(19) United States
(12) Patent Application Publication
(10) Pub. No.: US 2014/0129255 A1
(43) Pub. Date: May 8, 2014

(54) Medical Information and Scheduling Communication

(71) Applicants: James Thomas Woodson, Longview, TX (US); John Timothy DiPasquale, Longview, TX (US); Stanley Dean Upchurch, Longview, TX (US); Christopher Laird Dunnahoo, Longview, TX (US); Faber Allen White, Longview, TX (US); Justin Dale Schaper, Plano, TX (US); Kenneth Charles Cunningham, White Oak, TX (US); Jonathan Wesley Sandruck, Colleyville, TX (US); Luis Guillermo Zinser, Dallas, TX (US)

(72) Inventors: James Thomas Woodson, Longview, TX (US); John Timothy DiPasquale, Longview, TX (US); Stanley Dean Upchurch, Longview, TX (US); Christopher Laird Dunnahoo, Longview, TX (US); Faber Allen White, Longview, TX (US); Justin Dale Schaper, Plano, TX (US); Kenneth Charles Cunningham, White Oak, TX (US); Jonathan Wesley Sandruck, Colleyville, TX (US); Luis Guillermo Zinser, Dallas, TX (US)

(21) Appl. No.: 13/667,631

(22) Filed: Nov. 2, 2012

(51) Int. Cl. G06Q 50/24

(52) U.S. Cl. 705/3

(57) ABSTRACT

Technologies for medical information and scheduling communication include verifying the identity of a patient and determining a personal health record (PHR) controlled by the patient. Furthermore, the method includes, upon request of the patient, authorizing selective access to the PHR by an entity and selectively pushing information from the PHR to the entity, performing a real-time medical information activity associated with the PHR and the entity, and adding the activity to the PHR.

### TECHNICAL FIELD OF THE INVENTION

The present invention relates generally to medical informatics and, more particularly, to medical information and scheduling communication.

### BACKGROUND

Medical informatics includes cross-disciplined application of computer science, information technology, and healthcare. Medical informatics solutions include providing methods, resources, and devices to facilitate the care of patients by doctors and nurses who have needs to use acquisition, storage, retrieval, and use of information. Many medical informatics solutions use off-the-shelf tools for information technology components, such as servers, communication protocols, data storage, processing, and imaging.

Medical informatics may include processing of electronic health records (EHR). EHRs may be designed for use by health care providers to record data and may be dissimilar to personal health records (PHR). An EHR may be generated and owned by a healthcare provider, though a patient may have legal or privacy rights in the EHR. Data in a PHR may be owned by the patient. Furthermore, an EHR may be available through a patient portal, which may merely give a patient access to a healthcare entity's medical informatics systems to see an EHR pertaining to the patient.

### SUMMARY

In one embodiment, a method for medical information communication includes verifying the identity of a patient and determining a personal health record (PHR) controlled by the patient. Furthermore, the method includes, upon request of the patient, authorizing selective access to the PHR by an entity and selectively pushing information from the PHR to the entity, performing a real-time medical information activity associated with the PHR and the entity, and adding the activity to the PHR.

In another embodiment, an article of manufacture includes a computer readable medium and computer-executable instructions carried on the computer readable medium. The instructions are readable by a processor. The instructions, when read and executed, cause the processor to verify the identity of a patient and determine a PHR controlled by the patient. The instructions further cause the processor to, upon request of the patient, authorize selective access to the PHR by an entity and selectively pushing information from the PHR to the entity, perform a real-time medical information activity associated with the PHR and the entity, and add the activity to the PHR.

In yet another embodiment, a system for medical information communication includes a processor, a computer readable medium communicatively coupled to the processor, and computer-executable instructions carried on the computer readable medium. The instructions are readable by the processor. The instructions, when read and executed, cause the processor to verify the identity of a patient and determine a PHR controlled by the patient. The instructions further cause the processor to, upon request of the patient, authorize selective access to the PHR by an entity and selectively pushing information from the PHR to the entity, perform a real-time medical information activity associated with the PHR and the entity, and add the activity to the PHR.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example embodiment of a system for medical information tracking;

FIG. 2 illustrates the operation of an example embodiment of a system for medical information tracking;

FIG. 3 is a more detailed view of an example embodiment of server application;

FIG. 4 illustrates an example embodiment of patient application;

FIG. 5 illustrates an example templatized communication view;

FIG. 6 illustrates an example embodiment of a view including options for a user to indicate readiness;

FIG. 7 illustrates an example embodiment of a view including options for a patient to enter regarding assistance;

FIG. 8 illustrates an example embodiment of a view including options for a user to indicate symptom;

FIG. 9 illustrates an example embodiment of a view including options for a user to indicate needs

FIG. 10 illustrates a body map configured to provide a patient the ability to indicate where symptoms are appearing;

FIG. 11 illustrates an example embodiment of a conversation view;

FIG. 12 illustrates an example embodiment of a caregiver application;

FIG. 13 illustrates an example embodiment of an emergency medical service application;

FIG. 14 illustrates an example embodiment of an add patient module;

FIG. 15 illustrates of an example embodiment of a communications module; and

FIG. 16 illustrates an example embodiment of a method for medical information tracking.

### DETAILED DESCRIPTION

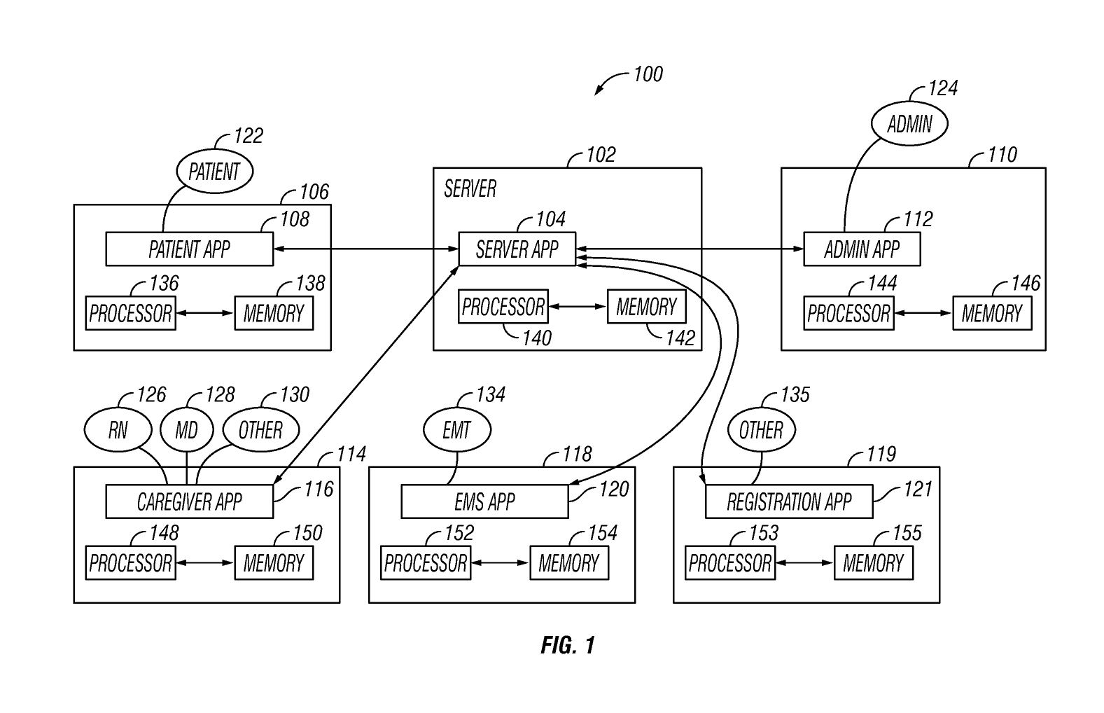

FIG. 1 illustrates an example embodiment of a system 100 for medical information tracking. In one embodiment, operation of system 100 may include a patient initiated distribution of a personal health record (PHR) to one or more other users of system 100.

System 100 may include the distributed or consolidated operation of one or more applications, such as patient application 108, server application 104, admin application 112, caregiver application 116, emergency medical service (EMS) application 120, or registration application 121. Each such application may be operating on different electronic devices 102, 106, 110, 114, 118, 119. Information collected, generated, or otherwise produced by one of patient application 108, admin application 112, caregiver application 116, EMS application 120, or registration application 121 may be communicated to another such application through server application 104. Server application 104 may be configured to store such communication, determine recipients, send messages, and provide additional information to such applications. Any suitable combination of number, particular implementations, or kinds of patient application 108, server application 104, admin application 112, caregiver application 116, EMS application 120, or registration application 121 may be used within system 100.

A given one of patient application 108, server application 104, admin application 112, caregiver application 116, EMS application 120, or registration application 121 may be configured to be used by a class or subclass of user. For example, patient application 108 may be configured to be used by a patient 122. Caregiver application 116 may be configured to be used by a nurse 126, doctor 128, or other 130 medical professional. The particular instance of caregiver application 116 may be configured to be conformed to a particular kind of users, such as nurse 126 versus doctor 128. Such configuration may include selective use or employment of particular features specific to, for example, a nurse or a doctor. EMS application 120 may be configured to be used by an emergency medical technician (EMT) 124. Server application 104 may be configured to be controlled by an administrator 124 of system 100 through, for example, admin application 112. Registration application 121 may be configured to be used by an other 130 medical professional, such as a supervisor, emergency room administrator, doctor, or nurse. The selective configuration of each of the applications for a given user may be made by, for example, altering the options and features presented to a specific or class of users.

Each of patient application 108, server application 104, admin application 112, caregiver application 116, EMS application 120, and registration application 121 may be implemented in unique, similar, or separate manners. For example, each such application may be executed out of a single codebase modified during execution for a particular user. In another example, each such application may represent a different codebase. Each of patient application 108, server application 104, admin application 112, caregiver application 116, EMS application 120, and registration application 121 may be implemented in any suitable fashion, such as by modules, logic, instructions, executables, libraries, functions, scripts, applications, hardware, software, firmware, input/output mechanisms, displays, views, or any suitable combination thereof. In one embodiment, some or all of each of patient application 108, server application 104, admin application 112, caregiver application 116, EMS application 120, and registration application 121 may be implemented by instructions or logic in a computer-readable medium or memory. The instructions may be executable by a processor and, when executed, perform the functionality described herein. Execution by the processor may cause one or more changes within the processor, such as to encoders, decoders, caches, or registers.

Communication between patient application 108, admin application 112, caregiver application 116, EMS application 120, registration application 121, and server application 104 may be made through any suitable connection, such as by a wireless or wired network. Such networks may include or use, for example, an intranet, the Internet, mobile phone or cellular networks, 802.11 class communications, text, transport control protocol, Internet protocol, hypertext transfer protocol, Ethernet, or any other suitable mechanism. Such networks and protocols may be secured according to ethical and legal requirements to protect patient privacy. In one embodiment, unsecure methods, such as short messaging service (SMS) texts, may be insufficiently secure and thus not used.

Each of electronic devices 106, 102, 110, 114, 118, 119 may be implemented in any suitable manner, such as by a server, computer, laptop, mobile phone, tablet, or other suitable electronic entity. Each of electronic devices 106, 102, 110, 114, 118, 119 may include a respective processor 136, 140, 144, 148, 152, 153 communicatively coupled to a respective memory 138, 142, 146, 150, 154, 155. In one embodiment, each of patient application 108, server application 104, admin application 112, caregiver application 116, EMS application 120, and registration application 121 may be resident fully or partially within respective memories 138, 142, 146, 150, 154, 155 and executed by respective processors 136, 140, 144, 148, 152, 153.

Processors 136, 140, 144, 148, 152, 153 may comprise, for example, a microprocessor, microcontroller, digital signal processor (DSP), application specific integrated circuit (ASIC), or any other digital or analog circuitry configured to interpret and/or execute program instructions and/or process data. In some embodiments, processors 136, 140, 144, 148, 152, 153 may interpret and/or execute program instructions and/or process data stored in memories 138, 142, 146, 150, 154, 155. Memories 138, 142, 146, 150, 154, 155 may be configured in part or whole as application memory, system memory, or both. Memories 138, 142, 146, 150, 154, 155 may include any system, device, or apparatus configured to hold and/or house one or more memory modules. Each memory module may include any system, device or apparatus configured to retain program instructions and/or data for a period of time (e.g., computer-readable storage media).

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (“RAM”), read-only memory (“ROM”), electrically erasable programmable read-only memory (“EEPROM”), and/or flash memory; as well as communications media such as wires, optical fibers, microwaves, radio waves, and other electromagnetic and/or optical carriers; and/or any combination of the foregoing.

A PHR may include a combination of information associated with a given patient. The information associated with a PHR may be controlled, directed, or owned by the patient, as opposed to a medical entity that may perform medical services or generate medical data. In system 100, all interactions with or actions of a given user through, for example, the patient's instance of patient application 108 may be logged to the PHR. Such a running log may include a continuing document of care (CDC), or a continuity of care document (CCD). Furthermore, a PHR may include electronic medical records (EMR) that have been received from various entities, such as individual hospitals, doctor's offices, or nursing homes. Such EMRs may be submitted to system 100 and added to a given PHR. Furthermore, live data collected on symptoms from a caregiver, patient, or medical device may be included in a PHR. In addition, communications between entities in system 100 regarding a patient may be included in the associated PHR. Other information, such as health history, current medical problems, past medical problems, immunization history, social history, family medical history, preferences, vital statistics, medications, previous medical data, lab results, or other medical information for a patient may be included in the associated PHR. Different portions or data of a PHR may be affirmed, updated, or verified from time-to-time. Such affirmation may be performed by, for example, the patient themselves or a caregiver. Consequently, the timeliness of the information within PHR may be noted by timestamps, verification metadata, or other mechanisms within the PHR itself.

A PHR may be implemented in any suitable manner. In one embodiment, a PHR may be defined with various fields and information according to an extensible markup language (XML) scheme. In another embodiment, a PHR may be defined according to various fields of a database.

In system 100, a patient may control disbursement of information within an associated PHR to various other entities. Furthermore, the patient may be able to selectively disburse portions of the associated PHR. Caregivers, EMTs, and other parties may be required to receive PHR information from centralized control of system 100, which gets its authorization for disbursement from the patient. Information may thus flow from one non-patient party to another by logging and selective disbursement by system 100, rather than direct communication between the parties.

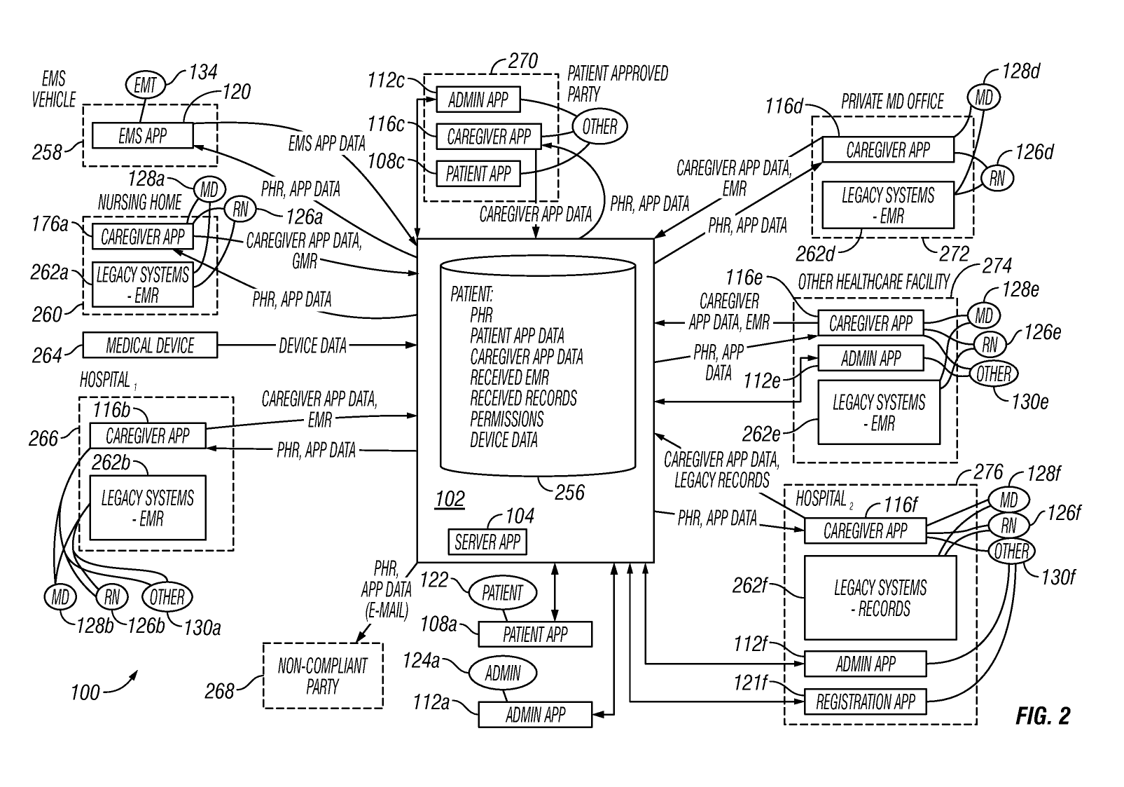

FIG. 2 illustrates the operation of an example embodiment of a system 100 for medical information tracking FIG. 2 illustrates various more detailed examples of instances of elements of system 100 and their operation.

Patient 122 may be using patient application 108a to access system 100. Patient application 108a may authorize use of a PHR for patient 122 in system 100 and selective access for one or more other users of system 100. Authorization of the use of data may include express authorization for particular users of system 100 to receive selections from the PHR. Upon receipt of authorization, server application 104 may be configured to push information such as the PHR to necessary application recipients. Server application 104 operating on server 102 may manage the medical information tracking for patient 122 and coordinate communication with other applications, including selectively sending medical information, such as the PHR, of patient 122 to other these applications. Furthermore, admin 124a may be using admin app 112a to operate, manager, or otherwise control system 100.

EMT 134 may be using an instance of EMS application 120 on an electronic device such as one in an EMS vehicle 258. EMS application 120 may transmit application data to server application 104, and receive pertinent data in return.

Doctor 128a or nurse 126a may be using an instance of caregiver application 116a at a nursing home 260. Furthermore, access may be made of legacy systems 262a which may include information such as an electronic medical record (EMR). Caregiver application 116a may transmit application information, as well as information such as the EMR from legacy systems 262a to server application 104. In return, server application 104 may send information in reply such as selections from patient's 122 PHR, or application data from other applications.

A medical device 264 may be configured to supply information to server application 104. Medical device 264 may be gathering information on, for example, patient 122. Medical device 264 may include, for example, an IV, a monitor, a breathing machine, scale, glucometer, blood pressure monitor, pulse monitor, oximeter, or any other suitable healthcare instrument. Server application 104 may be configured to update the PHR with the information in real-time. Furthermore, server application 104 may be configured to selectively provide the information as part of the PHR to one or more authorized users of system 100.

Doctor 128b, nurse 126b, or other party 130a may be using an instance of caregiver application 116b at a first hospital. Furthermore, access may be made of legacy systems 262b which may include information such as an EMR. Caregiver application 116b may transmit application information, as well as information such as the EMR from legacy systems 262b to server application 104. In return, server application 104 may send information in reply such as selections from patient's 122 PHR, or application data from other applications.

A non-compliant party 268 may include any entity that is not configured to interoperably or interactively exchange information with server application 104. Such a non-compliant party may include healthcare facilities, caregivers, companies, or other entities that operate only legacy or incompatible health informatics systems. Furthermore, a non-compliant party 268 may include other parties that a patient may wish to send medical information, such as friends or family members. Information may be configured to be sent in a generally accessible format, such as a document in portable data format (PDF). Such a document may be secured using, for example, a password. The password may be set by, for example, a patient who has initiated the transmission of information to non-compliant party 268. Server application 104 may be configured to provide information to a designated non-compliant party 268 through, for example, asynchronous methods such as mail or e-mail messages.

Yet another patient approved party 270, of any suitable kind or variation, may utilize an instance of admin application 112c, caregiver application 116c, or patient application 108c, or any combination thereof. Patient approved party 270 may include an entity to which patient 122, admin 124a, or a caregiver has delegated authority or responsibility. Patient-approved party 270 may transmit application information to server application 104. In return, server application 104 may send information in reply such as selections from patient's 122 PHR, or application data from other applications

Doctor 128d or nurse 126d may be using an instance of caregiver application 116d at a private medical doctor's (MD) office 272. Furthermore, access may be made of legacy systems 262d, which may include information such as an EMR. Caregiver application 116d may transmit application information, as well as information such as the EMR from legacy systems 262d to server application 104. In return, server application 104 may send information in reply such as selections from patient's 122 PHR, or application data from other applications.

Doctor 128e, nurse 126e, or another party 130e may be using an instance of caregiver application 116e or admin application 112e at a healthcare facility of another, varying type such as a laboratory, outpatient center, urgent care clinic, or testing facility. Furthermore, access may be made of legacy systems 262e which may include information such as an EMR. Caregiver application 116e or admin application 112e may transmit application information, as well as information such as the EMR from legacy systems 262e to server application 104. In return, server application 104 may send information in reply such as selections from patient's 122 PHR, or application data from other applications.

Doctor 128f, nurse 126f, or another party 130f may be using an instance of registration application 121f, caregiver application 116f, or admin application 112f at a second hospital 276. Furthermore, access may be made of legacy systems 262f which may include information such as legacy records. Legacy records of legacy systems 262f may be incompatible or of a different type than, for example, EMR of legacy systems 262b. Caregiver application 116f or admin application 112f may transmit application information, as well as information such as records from legacy systems 262f to server application 104. In return, server application 104 may send information in reply such as selections from patient's 122 PHR, or application data from other applications. Users at another facility, such as hospital 266, may utilize instances of, for example, caregiver application 116b, to view the records from legacy systems 262f that have been transmitted to server application 104. Likewise, instances of caregiver application 116f may be configured to view the records from legacy systems 262b such as an EMR. Registration application 121f may determine whether a patient has completed registration information for admittance to or treatment by the facility. Furthermore, one or more of caregiver application 116f or registration application 121f may be in communication with server application 104 to monitor patients who are en-route to hospital 276, or who have already arrived at hospital 276. Registration application 121f may determine the wait times, triage information, hospital forms and intake documentation status, admittance and discharge status, facility capacity, and other information regarding a given patient.

Server application 104 may be communicatively coupled to a PHR database 256. PHR database 256 may reside on server 102 or on any other suitable electronic device. PHR database 256 may organize information on a per-patient basis. PHR database 256 may include assembled received application data from applications of system 100 in a PHR for the patient. Furthermore, PHR database 256 may include data received from legacy systems such as records or EMRs. In addition, PHR database 256 may include permissions from an associated patient determining how information for the patient may be disbursed to applications of system 100. Furthermore, PHR database 256 may include device data received from various medical devices associated with a patient.

PHR database 256 may be implemented in any suitable manner. For example, PHR database 256 may be implemented by a database, files, data structures, or any other suitable entity. Furthermore, PHR database 256 may be implemented on any suitable electronic device or system, such as a server farm, cloud service, or storage array. PHR database 256 may include or may be communicatively coupled to storage service software configured to efficiently store, serve, and maintain its information. Information may be input into PHR database 256 from any suitable entity, such as patient application 108, admin application 110, caregiver application 116, EMS application 118, or registration 121. Furthermore, information may be input into PHR database 256 from, for example, other databases, legacy databases, medical devices, servers, cameras, scanners, or other suitable devices.

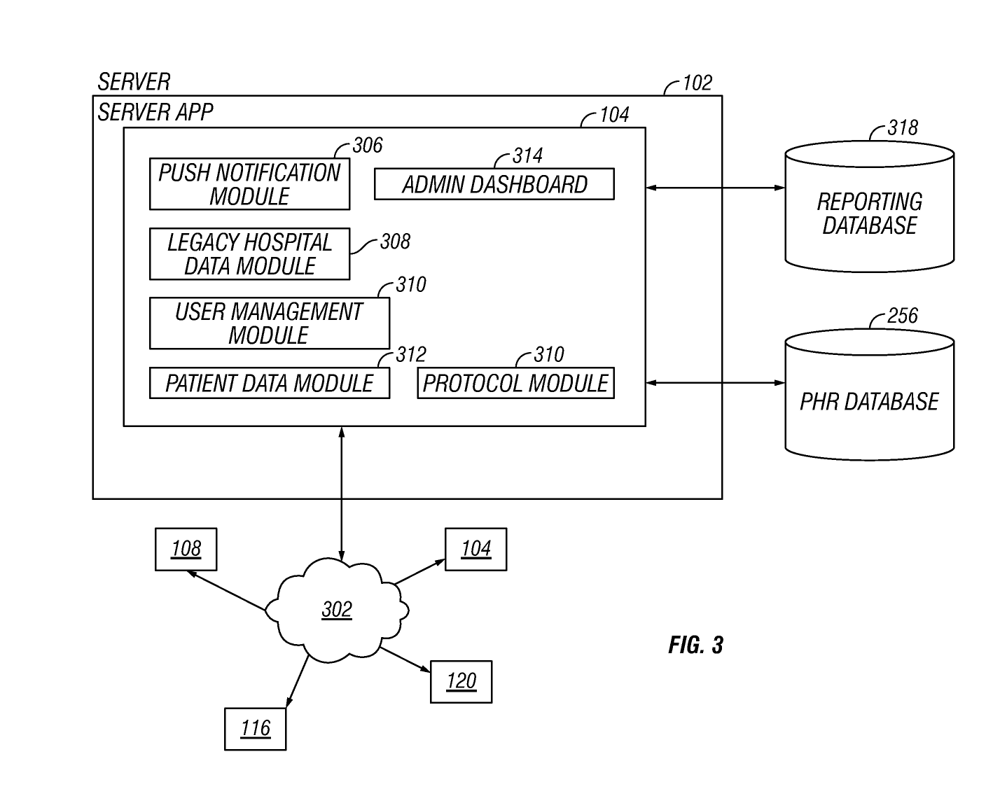

FIG. 3 is a more detailed view of an example embodiment of server application 104.

Server application 104 may include any suitable number, kind, or combination of components to perform the functionality described herein. For example, server application 104 may include a push notification module 306, legacy hospital data module 308, user management module 310, patient data module 312, admin dashboard 314, or protocol module 316. Each of push notification module 306, legacy hospital data module 308, user management module 310, patient data module 312, admin dashboard 314, and protocol module 316 may be implemented by any suitable application, script, executable, logic, instructions, functions, hardware, software, firmware, input/output mechanisms, displays, views, or any suitable combination thereof.

Push notification module 306 may be configured to determine consumers or recipients of information, such as selective portions of a patient's PHR, and to send the information or an indicator of the information to the recipient. Such recipients may include caregiver 116, patient 108, EMS 120, or admin 112 applications. Such information may be sent using, for example, text, SMS, hypertext transmission protocol (HTTP), file transfer protocol, transport control protocol, internet protocol, or any other suitable electronic manner.

Legacy hospital data module 308 may be configured to translate, store, retrieve, or otherwise handle information from systems not compliant, integrated, or included within system 100. Such information may be received by server application 104 from various application instances in system 100. Legacy hospital data module 308 may be configured to selectively include relevant portions of such information and attach or associate the portions with a patient's PHR.

User management module 310 may be configured to track, manage, or otherwise handle users of system 100. User management module 310 may define permissions, handle data transactions, set on-call or on-duty notices, or determine personnel who are on-duty or on-call for caregivers such as EMTs, nurses, or doctors, or patients.

Patient data module 312 may be configured to track, manage, or otherwise handle patients of system 100. Patient data module 310 may be configured to control access to a patient's PHR or other information.

Admin dashboard 314 may be configured to provide a view and options for an administrator of system 200 to perform maintenance, set preferences, make manual adjustments, or perform other supervisory tasks.

Protocol module 316 may be configured to translate, interpret, or otherwise communicate with various disparate portions of system 100. Protocol module 316 may define technical and policy requirements for encryption, authentication, or privacy to be used in accordance with data transactions of system 100. Furthermore, protocol module 316 may be configured to define how medical information may be defined and translated between different formats.

For example, protocol module 316 may be configured to determine medical information defined according to Health Level Seven (HL7) definitions that may be used in messages to convey a medical status, or in commands for logical operation between applications such as instances of caregiver application 116. Such HL7 information may be wrapped by protocol module 316 with a query control wrapper defining how the underlying information is represented and may be used. Furthermore, such query control data may itself be wrapped by protocol module 316 in a transmission wrapper, configured to include constructs for message identification, addressing (such as an intended application target or source), etc. In addition, information within such a transmission wrapper may be wrapped into general data exchange structure protocol layers, such as extensible markup language (XML) or Simple Object Access Protocol (SOAP). Such data may itself be wrapped into transportation protocol layers, such as TCP/IP or HTTP.

Each of caregiver 116, patient 108, EMS 120, registration 121, or admin 112 applications may implement a protocol module similar to protocol module 316 and configured to facilitate, transmit, and translate medical information and operational commands.

Server application 104 may be communicatively coupled to one or more databases, such as PHR database 256 or reporting database 318. Reporting database 318 may be configured to store an indication of actions taken by server application 104 for a given patient, system actions taken by server applications, or settings or data received from various applications connected to server application 104 and received therein. Reporting database 318 may be implemented in any suitable manner or on any suitable system. Server application 104 may be configured to store information associated with a given patient in the associated PHR in PHR database 256. Furthermore, server application 318 may be configured to store information about actions taken in reporting database 318.

As shown above, server application 104 may be communicatively coupled to any suitable kind, number, or combination of other applications such as caregiver 116, patient 108, EMS 120, or admin 112 applications. Server application 104 may be communicatively coupled to such entities through any suitable mechanism, such as one or more networks 302. Furthermore, each of caregiver 116, patient 108, EMS 120, or admin 112 applications may be communicatively coupled to each other through any suitable mechanism, such as one or more networks 302. Networks 302 may be, for example, wired, wireless, fiber-optic, coaxial cable, 802.11-class, Bluetooth, microwave relay, or any suitable combination thereof.

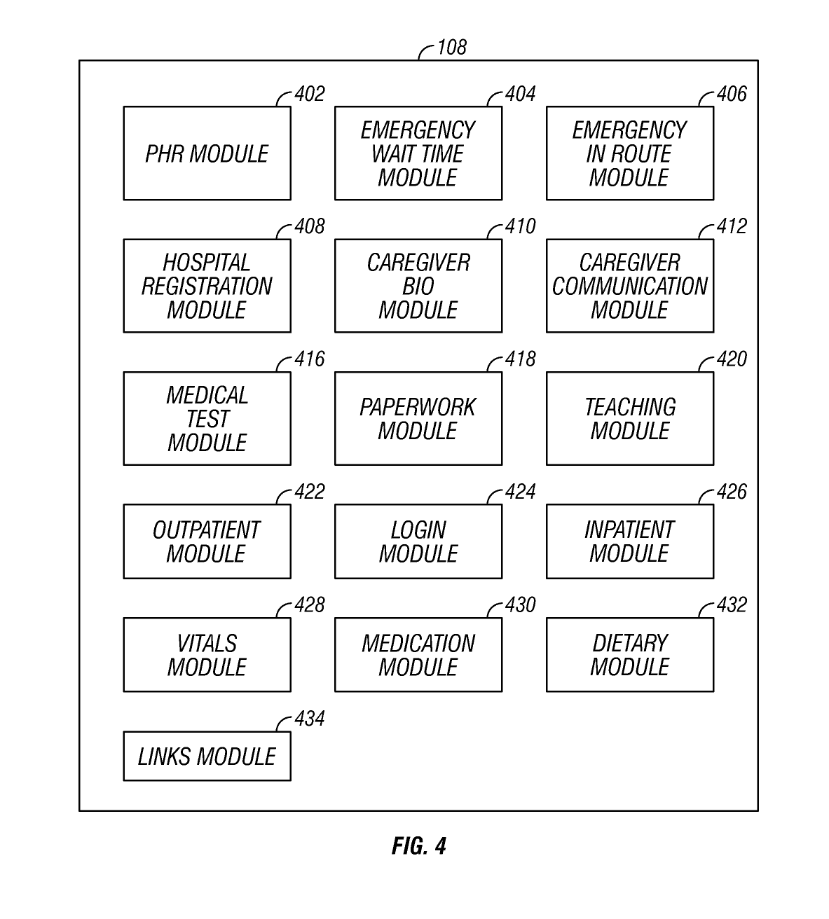

FIG. 4 illustrates an example embodiment of patient application 108. Patient application 108 may include any suitable number of modules, interfaces, and displays to perform the operation as described herein. Each module may be implemented by any suitable combination of code, logic, applications, scripts, functions, executables, firmware, input/output mechanisms, displays, views, software, or hardware. For example, patient application 108 may include a PHR module 402, emergency wait time module 404, emergency en-route module 406, hospital registration module 408, caregiver bio module, caregiver communication module 412, medical test module 416, paperwork module 418, teaching module 420, outpatient module 422, login module 424, inpatient module 426, vitals module 428, medication module 430, dietary module 432, and links module 434. Each such module may be associated with one or more user screens configured to provide input and output to a user of patient application 108. Furthermore, each such module may be configured to cause information to be sent to another portion of system 100, such as to server 102 for distribution to caregiver applications.

PHR module 402 may be configured to illustrate any suitable aspect of a PHR record for the user of patient application 108. Furthermore, PHR module 402 may be configured to issue or authorize a PHR, or a subset thereof, to a third party, such as an EMT, caregiver, or healthcare facility system. PHR module 402 may include information for a user of patient application 108 such as user information, preferences, personality information, medical history, medications and medication allergies, caregiver information, insurance information, legal advance directives, and vital medical information. PHR module 402 may include any suitable mechanism for inputting, editing, or verifying elements of the PHR. Furthermore, PHR module 402 may be configured to selectively send or authorize any subset of such information of the PHR to a designated recipient. Also, PHR module 402 may be configured to selectively seek verification of any subset of such information of the PHR from a user of patient application 108. Such user information may include name, address, identification numbers, contact information for a user of patient application 108, and emergency contacts for a user of patient application 108. PHR module 402 may include an option for pushing, publishing, or sharing the information to other users or elements of system 100. Upon selection of such an option, PHR module 402 may be configured to display any suitable combination of indicators or documents to inform a user of the consequences of such sharing. For example, PHR module 402 may be configured to display a release, warning, disclosure, or other information that must be acknowledged by the user before the information will be shared. PHR module 402 may be used in conjunction with any suitable aspect of patient application 108. The information sent or authorized by PHR module 402 may be sensitive to the context in which it is invoked. For example, check-in to a hospital or an on-may-way message may be accompanied by a PHR with current vital statistics. In another example, outpatient communication may be accompanied with information about medication dosage usage or educational videos that have been watched.

User preferences may include a default designation of preferred healthcare facilities. Such facilities may be given default access to the PHR or may be used in conjunction with emergency wait time module 404 or emergency en-route module 406. User preferences may also include pharmacy information. Furthermore, user preferences may include options to allow caregivers in system 100 to update a PHR, EMS workers in system 100 to access the PHR, or allow healthcare facility registrations to access the PHR. Accordingly, a user of patient application 108 may be given control of the PHR. Furthermore, the user preferences may include options for enabling alerting authorized users of system 100 to view an on-the-way-to-emergency-room status, emergency notes from an emergency room, notes from admission to a healthcare facility, and notes from discharge from a healthcare facility.

Furthermore, PHR module 402 may include communication with other entities in system 100 into a given PHR for a given user of patient application 108.

In addition, PHR module 402 may be configured to allow a user of patient application 108 to forward the PHR to any specified user of system 100, such as a specific caregiver, a facility generally, or a department of a facility. PHR module 402 may be configured to allow a user of patient application 108 to see the information that is to be forwarded before forwarding such information. PHR module 402 may include just-in-time mechanisms to selectively edit, verify, or delete any such part of the PHR before forwarding it. PHR module 402 may present one or more entities, caregivers, or other destinations of a PHR to a user of patient application 108.

Medical history information may include ongoing medical conditions including date of onset, prior medical conditions including relevant dates, surgical history including dates, family medical history, immunization history, vital signs, medications, allergies, and social history including risk factors and drug use.

Caregiver information may include a caregiver identified as a user of system 100. The identification of the caregiver may be selectable from a list of users of system 100. A caregiver may be designated, for example, as a specialist or primary care physician.

Insurance information may include primary or secondary insurance account information. Insurance information may be uploaded to the PHR by use of, for example, a camera on an electronic device upon which patient application 108 is operating.

Legal advance directive information may include do-not-resuscitate information, specific directives to physicians, medical power of attorney, mental health directives, or organ donor information. Each such information may be enabled or disabled. Furthermore, a camera attached to an electronic device upon which patient application 108 is operating may be used to scan or capture such forms. Furthermore, each such piece of information may be individually forwarded or verified.

Emergency wait time module 404 may be configured to determine, for one or more emergency facilities, a wait time for a user of patient application 108. Emergency wait time module 404 may be configured to provide such information for a specified or selected facility of system 100. The information may include wait times for various degrees of severity, such as minor, urgent, and emergency situations. Emergency wait time module 404 may make such determinations by evaluating the workloads, staffing, cases, or other real-time information at the facility. Emergency wait time module 404 may be configured to accept information regarding a severity of a condition from a user of patient application 108. Such a severity may be defined quantitatively or qualitatively. Furthermore, emergency wait time module 404 may be configured to suggest emergency room units, urgent care units, or other medical facilities based upon severity of a condition indicated by a user of patient application 108. In addition, emergency wait time module 404 may be configured to suggest emergency room units, urgent care units, or other medical facilities based upon a location of a user of patient application 108, directing a user to a closest facility. The location of the user may be provided by a GPS sensor on an electronic device operating patient application 108, by inferring location based on wireless communication stations, or by any other suitable method. Based on a user's location, emergency wait time module 404 may be configured to provide directions to a facility to a user. Such directions may be provided through, for example, a map interface. The configuration of emergency wait time module 404 may also be used by, for example, EMS application 120 or registration application 121 to determine wait times, patient loads, routing of patients, or estimated times of arrival.

Furthermore, emergency wait time module 404 may be configured to accept a planned arrival time for a user of patient application 108. Emergency wait time module 404 may accept input regarding a medical emergency condition as well as arrival mode. The planned arrival time may be, for example, accepted through input from a user of patient application 108, or determined through geographic location of the user and the planned mode of transport, such as car or ambulance. The planned arrival time may be updated and sent to system 100 upon, for example, changing traffic conditions detected in relation to the geographic location of the patient.

Emergency en-route module 406 may be configured to provide emergency room, urgent care, or other facility check-in for a user of patient application 108. Such a check-in may be made before a user of patient application 108 leaves for the specified facility. Emergency en-route module 406 may solicit triage information from a user of patient application 108 and provide the information to the facility, along with a PHR of the user. Emergency en-route module 406 may include an interactive display of a human body to provide triage information including selectable symptoms.

Emergency en-route module 406 may also be configured to receive and display push notifications or other messages from a caregiver while the patient is en-route to or has arrived at the facility. Such notifications may include, for example, additional inquiries as to medical history, authorizations, symptoms, or other necessary information.

Furthermore, if a patient is en-route to a facility, as communicated by any suitable mechanism such as emergency en-route module 406 or EMS application 120, the facility may be configured to receive the en-route information from the patient and prioritize the patient. The patient may be placed in a higher priority if arriving by EMS. Also, emergency en-route module 406 may be configured to communicate with system 100 to provide arrival status, check-in status, room assignment, or other information.

In addition, emergency en-route module 406 may include options for a shortcut or one-button option to dialing an emergency help number, such as 9-1-1 or a caregiver at the facility.

Hospital registration module 408 may be configured to provide a series of steps for a user of patient application 108 to check-in to a specified and specific healthcare facility. Such steps may be similar to emergency en-route module 406. Hospital registration module 408 may be configured to prompt a user to review and verify certain portions of the PHR, such as contact information, medical history, medications, and allergies. Furthermore, hospital registration module 408 may prompt a user to fill out, sign, or verify specified forms releases, directives, permissions, authorizations, notices, or other documents. Hospital registration module 408 may be configured to provide the ability to digitally or electronically sign such forms. The forms may be stored and may be printable with such a signature located in the correct position. Hospital registration module 408 may communicate with, for example, an instance or users of registration application 121 to determine forms to be filled out. Some or all of hospital registration module 408 may be accessible or used by other portions of patient application 108 to sign forms as necessary within a variety of contexts, such as transport through EMS, visiting a healthcare facility, paperwork required for medical insurance or outpatient care, or any other suitable circumstance.

Hospital registration module 408 may include any suitable components for providing for a user to sign various forms, releases, directives, permissions, authorizations, notices, or other documents. Hospital registration module 408 may include a signature line, checkboxes, or other mechanism for indicating an acceptance or affirmation. In one embodiment, hospital registration module 408 may include mechanisms configured to provide corroboration to the user's acceptance. For example, a device upon which patient application 108 is executing may be equipped with a still or video camera. If such a camera is front-facing, wherein the camera faces a user using the electronic device, the camera may be activated and capture the action of the user actually electronically signing the form. The resultant image or video clip may be stamped with a date, time, and determined geographic location. The stamped information may be encoded so as to prevent corruption, tampering, or forgery. Furthermore, the input of electronic device may be recorded in real-time, using such techniques such as a screen-capture. A window of hospital registration module 408 may display the process that is being recorded or captured in real-time. The corroborating information may be reviewable by the user or another entity, such as a user of registration application 121, at a later time.

In addition, hospital registration module 408 may prompt a user to verify that the user is visible or recognizable to such a camera during the process of signing. Hospital registration module 408 may determine whether a face is visible or recognizable within the frame of the camera. If a camera of the electronic device upon which patient application 106 is operating is not front facing, then hospital registration module 408 may be configured to prompt a user to take a picture of the user's self immediately before or after signing the forms. The resultant date, time, and location stamp may thus indicate that the user was present at a time and place close to the signing of the forms. Furthermore, signing such forms may trigger hospital registration module 408 to prompt a user to verify log-in information, such as a username and password, QR code, or fingerprint. Such information may further corroborate the signing of the forms.

Caregiver bio module 410 may be configured to display a biographical background of a caregiver assigned to or available to be assigned to a user of patient application 108. The selection of a caregiver may be made by presenting a user of patient application 108 one or more choices of healthcare facilities or participating caregivers of system 100. Given a selected healthcare facility, caregiver bio module may present one or more caregivers to select to a user of patient application 108. In one embodiment, caregiver bio module 410 may by default present options to show a background of caregivers currently assigned within system 100 to a user of patient application 108. The bio background may detail education, specialization, or other information. Caregiver bio module 410 may include a button or other mechanism for contacting an identified caregiver. Such a mechanism may be implemented in conjunction with, for example, caregiver communication module 412. The bio background may be maintained, managed, edited, or otherwise controlled by, for example, an instance of caregiver application 116 or administration application 112.

Caregiver communication module 412 may be configured to facilitate, record, and display communications between a caregiver and a user of patient application 108. Such a caregiver may be a user of system 100 through, for example, caregiver application 116. Caregiver communication module 412 may be configured to be used in conjunction with one or more other modules of patient application 108. For example, caregiver communication module 412 may be used to facilitate or record specific communications with caregivers to give triage information in conjunction with emergency en-route module 406. In another example, caregiver communication module 412 may be used to facilitate specific or record specific communications with caregivers while a patient is admitted to a healthcare facility as used in inpatient module 426, or after discharge in outpatient module 422. Caregiver communication module 412 may be configured to display a series of messages between a user of patient application 108 and a caregiver. Such messages may have been transported using any suitable communications mechanism, such as text messages, instant messages, or other electronic messaging. Information from caregiver communication module 412 may be attached to the PHR. In one embodiment, such information may be selectively included in the PHR in association with particular diagnoses or medical conditions. In one embodiment, outpatient module 422 may include a customizable pill alert. The pill alert may include views, functions, or other mechanisms to enter a medication to be taken, when the medication is to be taken, and an acknowledgement of whether the medication was taken. Furthermore, outpatient module 422 may be configured to report or log usage data, or to receive updates from or synchronize with another portion of system 100.

Caregiver communication module 412 may present a templatized mechanism for a user of patient application 108 to input communication to a caregiver. Such a templatized approach may be used to standardize, simplify, and focus communication from a user of patient application 108 to a caregiver. The templatized mechanism may include a hierarchy of possible communications that can be built upon each other. In one embodiment, various aspects of the templatized mechanisms may be implemented with pictures, graphics, pictograms, or other graphical presentation. In another embodiment, various aspects of the templatized mechanisms may be configured to be presented and translated into various foreign languages according to the preferences of patient application 108.

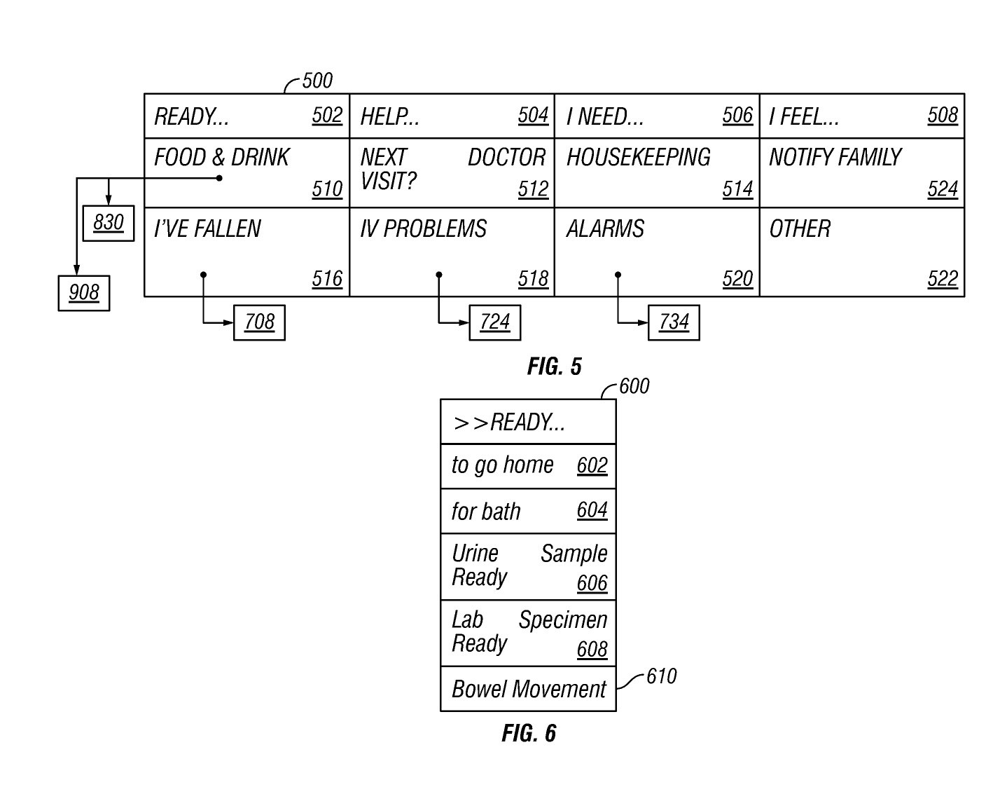

FIG. 5 illustrates an example templatized communication view 500 that may implement communication in, for example, caregiver communication module 412. View 500 may be implemented by, for example, displays, menus, software modules, input-output mechanisms such as sliders, buttons, voice-clip capture, cameras, pictograms, graphics, images, and textboxes. View 500 may include a hierarchy of possible actions that may be taken by a user of patient application 108. The contents of view 500 may be configured according to a healthcare situation of the patient. In the example of FIG. 5, view 500 may be substantially shown as for a patient in a hospital, emergency room, nursing facility, or doctor's office.

In one embodiment, each level of the hierarchy may add an element of a desired communication for a user of patient application 108. For example, view 500 may include an option 502 for a user to declare that the user is ready for some action, task, or activity. View 500 may include an option 504 for a user to declare that the user needs assistance with something. Furthermore, view 500 may include an option 506 for a user to declare that the user needs something. In addition, view 500 may include an option 508 for a user to report a feeling, symptom, or other medical condition.

In another embodiment, view 500 may present shortcuts at a top-level of such a hierarchy to simply important or critical communications for a user of patient application 108. In one further embodiment, some such shortcuts may be shortcuts to other portions of the hierarchy that may have been accessible through drilling down of other options. For example, view 500 may include an option 510 for a user to declare that the user needs something to eat or drink. Option 510 may correspond to, for example, options 830 or 908, discussed below. View 500 may include an option 516 for a user to declare that the user has fallen. Option 516 may correspond to, for example, option 724, discussed below. View 500 may include an option 518 for a user to declare that a problem exists with an intravenous device (IV). Option 518 may correspond to, for example, option 724, discussed below. View 500 may include an option 520 for a user to declare that one or more alarms are going off. Option 520 may correspond to, for example, option 734, discussed below. In another, further embodiment, some such shortcuts may represent terminal options without sub-choices that reside within view 500. For example, view 500 may include an option 512 for a user to ask when the next time a doctor will visit. Furthermore, view 500 may include an option for a user to ask for housekeeping for a hospital room.

View 500 may include an option 524 for notifying other parties, such as family or friends. A high-level summary of the patient's condition may be sent to the specified recipient, along with an indication of the patient's room number. In one embodiment, option 524 may provide other options for specifying a phone number, e-mail, or other destination for a summary or report. In another embodiment, option 524 may determine recipient information from a PHR field designating, for example, next of kin or emergency contacts.

View 500 may include options 522 for other activities that may be grouped or presented in any suitable manner.

As described above, elements within the hierarchy of options of view 500 may correspond to other elements within the hierarchy of options of view 500. Ease-of-use may be increased by providing multiple avenues of reaching a desired action for a user of patient application 108. Any suitable cross-referencing of options may be performed within view 500 or its associated hierarchy.

View 500 may implement a variable presentation of options, including submenus or shortcuts. The variable configuration of 500 may be based upon, for example, a healthcare facility to which a patient is admitted or particular medical conditions of the patient. For example, option 518 may present a shortcut for IV problems if a patient is using an IV device. However, option 518 may be replaced if the patient is not using an IV, or may be shown in addition to a similar option for another device in use by the patient, such as a heart monitor. In another example, wherein a user has a frequent bowel problem and needs assistance getting out of bed, view 500 may be configured to include shortcut on the front display for assistance getting out of bed, wherein such an option is otherwise embedded within the hierarchy of options. Furthermore, the variable configuration of view 500 may based upon the entity that initiated a conversation. For example, a query initiated by a patient user of patient application 108 may include a full range of possible options to report a condition. In another example, a query initiated by a caregiver user of caregiver application 116 to a patient using patient application 108 to inquire about a specific symptom or experience may be shown in view 500 with options associated with the specific inquiry made by the caregiver.

Any one of the options presented in view 500 or in its hierarchy of options may be represented by text alone, a pictogram, an icon, a drawing, or any combination thereof. For example, option 510 may include a pictogram of a plate, knife, and fork, or of a glass or cup. Option 516 may include a pictogram or a person on a floor next to a bed. Option 520 may include an image of a red light flashing. Option 518 may include a picture of an IV device. Option 514 may include a pictogram of a broom or of a trash can being emptied.

When selected, options within view 500 or its hierarchy may be routed to an appropriate caregiver. Such a routing and delivery may be made through caregiver application 116. Messages or information generated by some options may be directed to a specific caregiver identified by a user of patient application 108. The appropriate routing of other messages may be determined by server application 104. Such routing may be determined by, for example, on-duty or on-call status of caregivers, the nature of the question, the assignment of a patient to one or more caregivers, or the initiator of the conversation. For example, options such as option 516 indicating that a patient has fallen need to be sent to the nearest caregiver. Server application 104 may route the message to on-duty or on-call nurses on the same floor, wing, or other part of a facility as the patient. A nurse may be selected over, for example, a specialist, because a nurse may be the most appropriate class of caregiver to handle the communication. Furthermore, any accessible on-call or on-duty nurses may be selected, as opposed to only specific nurses assigned to the patient, because handling such an issue requires no personalized handling. In contrast, selected options such as those requesting pain medications may be handled by pain-specialist nurses or doctors specifically assigned to the patient, as dispensation of such medication may require consideration of a greater range of larger issues and information. Furthermore, the dispensation may require accountability for the decision-making underlying such a medical decision.

Information communicated with a selection of an option from view 500 or its hierarchy may include selective information about the patient. The information may include the patient's name, age, gender, and location (such as room number). Furthermore, depending upon the context of the reported information, real-time medical data, portions of the patients PHR, or other information may be selectively harvested and sent to a caregiver. Upon receipt, a user of caregiver application 116 may have one-button or other expedited access the received information such as the PHR, radiology reports, laboratory reports, EMR notes, or current medications list.

For example, if a patient selects an option declaring that the user feels feverish, a history of temperature readings from the previous twenty-four hours may be delivered to the caregiver along with the alert originating from the original selection. In another example, if a patient selects an option declaring that the patient feels like they have low blood sugar, the patient's insulin regiment from the patient's PHR may be reported to the caregiver. Such information may be presented in-line with the alert or may be highlighted in a PHR view to the caregiver in caregiver application 116. In yet another example, a patient's dietary or water restrictions from a PHR may be presented simultaneously with a patient's electronic request for food, water, or ice.

Selection of options in view 500 and in its hierarchy may be stored to a PHR along with a timestamp.

For a given communication between a patient and a caregiver, or between two caregivers, an indication may be made to illustrate whether the message has been delivered and read. Such a “read” condition may include a determination of whether a conversation view including the message has been presented to the recipient.

Although specific examples of options in view 500 and in its hierarchy are presented herein, variations may be made in the selection and presentation of such options without varying from the spirit of embodiments of the present disclosure.

FIG. 6 illustrates an example embodiment of a view 600 including options for a user to indicate readiness. View 600 may illustrate further operations derived from selection of option 502 from view 500. In particular, view 600 may illustrate further options for a user to declare that the user is ready for an action, task, service, or other event.

For example, view 600 may include an option 602 for a user to declare that the user is ready to check out of the facility to return home. Option 602 may include a pictogram of a house. Selection of option 602 may be routed to an on-duty nurse or other caregiver or to hospital admitting staff using an instance of caregiver application 116 or admin application 112.

View 600 may include an option 604 for a user to declare that the user is ready for a bath or shower. Option 604 may include a pictogram of a showerhead and a person. Selection of option 604 may be routed to, for example, a nurse's aid or on-duty nurse or other caregiver using an instance of caregiver application 116.

View 600 may include an option 606 for a user to declare that a requested specimen, such as a stool or urine sample, is ready for pickup. Such a specimen may be available, for example, within the room of the patient. Selection of option 606 may be routed to, for example, a lab technician, doctor assigned to the patient, or nurse assigned to the patient using an instance of caregiver application 116. The information may include a room number of the patient.

View 600 may include an option 608 for a user to declare the patient is ready to give a lab specimen, such as blood. Selection of option 606 may be routed to, for example, a lab technician, doctor assigned to the patient, or nurse assigned to the patient using an instance of caregiver application 116.

View 600 may include an option 608 for a user to declare that the patient is ready to use the restroom. Option 608 may include a pictogram of a toilet, for example. Selection of option 608 may be routed to, for example, a nurse's aid or on-duty nurse or other caregiver using an instance of caregiver application 116.

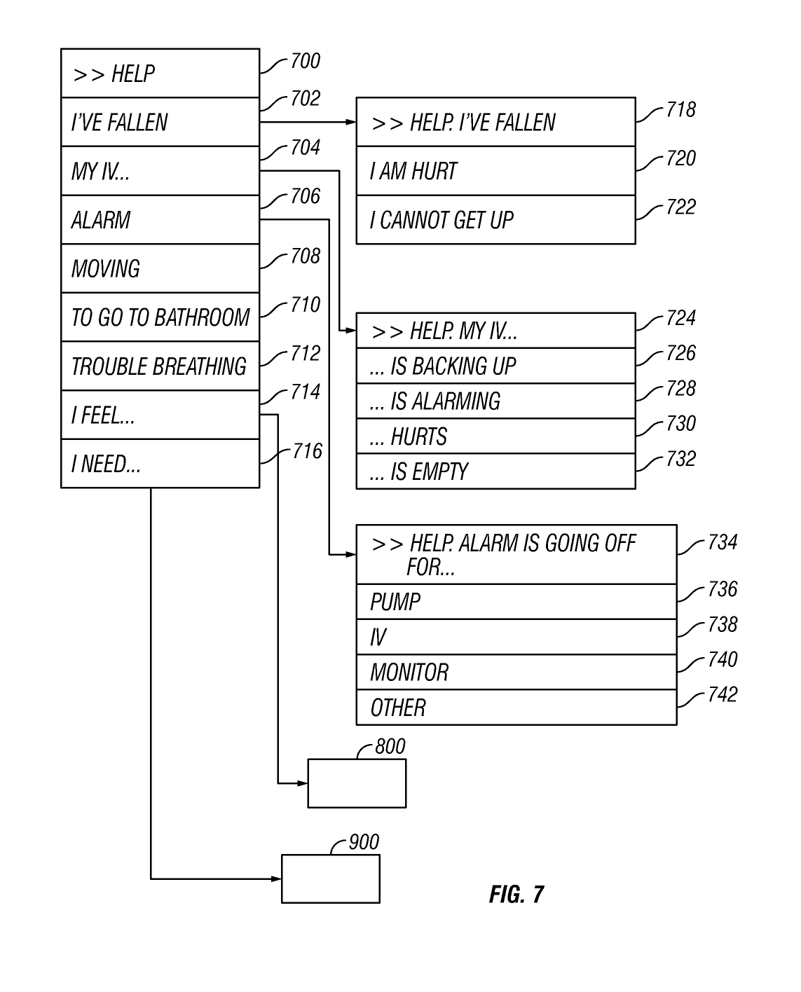

FIG. 7 illustrates an example embodiment of a view 700 including options for a patient to enter regarding assistance. View 700 may illustrate further operations derived from selection of option 504 from view 500. In particular, view 700 may illustrate further options for a user to declare that the user needs help in some fashion.

For example, view 700 may include an option 702 for a user to declare that the user has fallen. Option 702 may include, for example, a pictogram of a person on the ground next to a bed. Selection of option 702 may be routed to an on-duty nurse or other caregiver using an instance of caregiver application 116. Furthermore, selection of option 702 may cause additional options to be displayed, such as those within view 718. View 718 may summarize the selections made thus far, such as an indication that help is needed and that the patient has fallen. View 718 may include an option 720 for a user to declare that the user is also hurt. Option 720 may include, for example, a pictogram of a bandage, or of pain radiating from an appendage of a person. View 718 may include an option 722 for a user to declare that the user cannot stand up. Selection of one of options 720, 722 may be handled by patient application 108 by concatenating, evaluating, or logically combining the selections to form a single message to a caregiver through an instance of caregiver application 116. Furthermore, if one of options 720, 722 is not selected within a given time period, patient application 108 may send a message with base information—such as that help is needed because the patient has fallen.

View 700 may include an option 704 for a user to declare that the user needs help with a particular medical device, such as an IV. The display and operation of option 704 may be conformed to the type of medical device in use. For example, option 704 may include a pictogram of an IV and may generate a list of possible problems specific to IVs. Selection of option 704 or any of its subsequent options may be routed to an on-duty nurse or other caregiver using an instance of caregiver application 116. Selection of option 704 may cause additional options to be displayed, such as those within view 724. View 724 may summarize the selections made thus far. View 724 may include an option 726 for a user to declare that the IV is backing up and not dripping. Option 726 may include, for example, a pictogram of an IV with an “x” on the tube from the IV to a person. View 724 may include an option 728 for a user to declare that the IV is generating an alarm. Option 728 may include, for example, a picture of a red light flashing. View 724 may include an option 730 for a user to declare that the IV is hurting the patient. Option 730 may include, for example, a pictogram showing pain radiating from an appendage of a person. View 724 may include an option 732 for a user to declare that the IV is empty or has completed. Option 732 may include, for example, a pictogram of an IV with no contents or an image of fuel gauge on ‘E’. Selection of one of such options may be handled by patient application 108 by concatenating, evaluating, or logically combining the selections to form a single message to a caregiver through an instance of caregiver application 116. Furthermore, if one of such options is not selected within a given time period, patient application 108 may send a message with base information—such as that help is needed because of an IV.

View 700 may include an option 706 for a user to declare that help is needed because an alarm is going off. Option 706 may include, for example, an image of a flashing red light. Selection of option 706 or any of its subsequent options may be routed to an on-duty nurse or other caregiver using an instance of caregiver application 116. Selection of option 706 may cause additional options to be displayed, such as those within view 734. View 734 may summarize the selections made thus far. View 734 may include an option 736 for a user to declare that an alarm is going off for a pump. Option 736 may include, for example, a pictogram of a pump. View 734 may include an option 738 for a user to declare that the IV is generating an alarm. Option 738 may include, for example, a pictogram of an IV. View 734 may include an option 740 for a user to declare that a monitor is generating an alarm. Option 740 may include, for example, a pictogram of the monitor. View 734 may include an option 742 for a user to declare that another device is generating the alarm. Selection of one of such options may be handled by patient application 108 by concatenating, evaluating, or logically combining the selections to form a single message to a caregiver through an instance of caregiver application 116. Furthermore, if one of such options is not selected within a given time period, patient application 108 may send a message with base information—such as that help is needed because of an alarm.

View 700 may include an option 708 for a user to declare that the user needs help moving. Option 708 may include, for example, a pictogram of a person attempting to sit up in a bed. Selection of option 708 may be routed to a nurse's assistant, on-duty nurse, or other caregiver using an instance of caregiver application 116.

View 700 may include an option 710 for a user to declare that the user needs help going to the restroom. Option 710 may include, for example, a pictogram of a toilet. Selection of option 710 may be routed to a nurse's assistant, on-duty nurse, or other caregiver using an instance of caregiver application 116. Selection of option 710 may yield a similar communication as, for example, option 610.

View 700 may include an option 712 for a user to declare that the user has trouble breathing. Option 712 may include, for example, a pictogram of an oxygen mask. Selection of option 712 may be routed to an on-duty nurse, doctor, or other caregiver using an instance of caregiver application 116.

View 700 may include an option 714 for a user to declare that the user needs help because the user is feeling a certain way or experiencing a specific condition. Option 714 may yield a similar or same sequence of operation as selection of option 508 and may be handled as shown by view 800, discussed below.

View 700 may include an option 716 for a user to declare that the user needs help because the user needs something. Option 716 may yield a similar or same sequence of operation as selection of option 506 and may be handled as shown by view 900, discussed below.

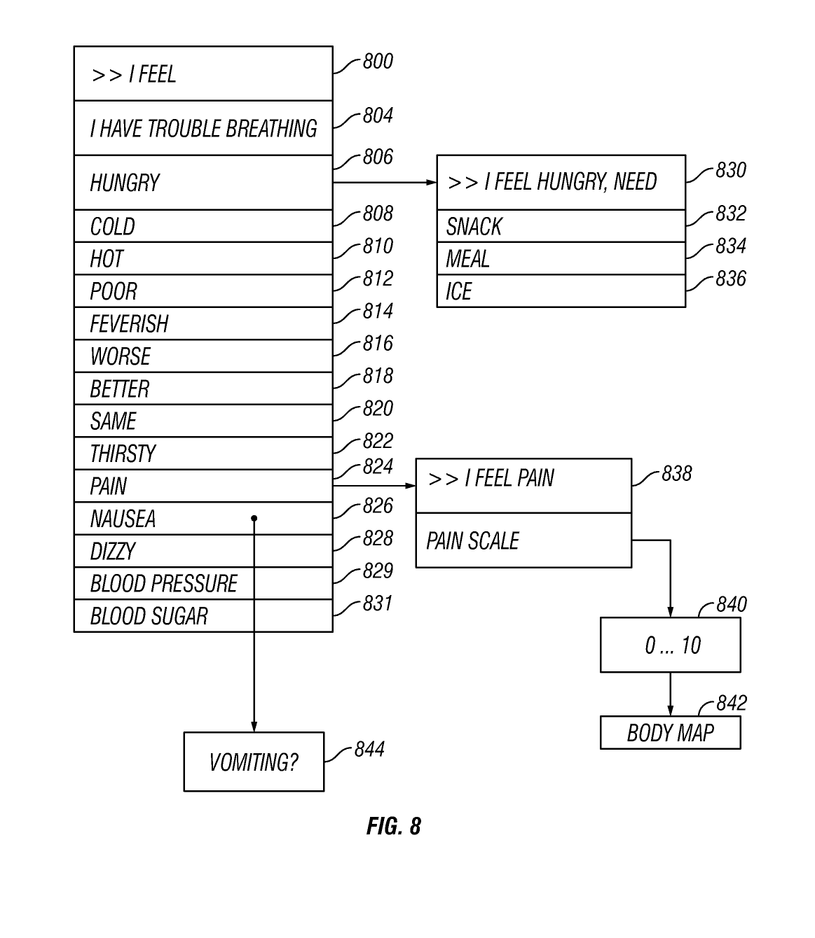

FIG. 8 illustrates an example embodiment of a view 800 including options for a user to indicate symptoms. View 800 may illustrate further operations derived from selection of option 508 from view 500. In one embodiment, view 800 may illustrate operations derived from selection of option 714 from view 700. In particular, view 800 may illustrate further options for a user to declare that the user is experiencing a particular feeling, condition, or symptom. Selection of an option within view 800 may be handled by patient application 108 by concatenating, evaluating, or logically combining the selections to form a single message to a caregiver through an instance of caregiver application 116. Furthermore, if an option is not selected within a given time period, patient application 108 may send a message with base information representing selections made thus far. Each element or option of view 800 may include a subsequent option for a user to indicate a severity level. Such levels may be made, for example, with a numeric range (such as one to ten), a qualitative range (such as less, much less, more, much more), or pictograms, pictures, or other images.

For example, view 800 may include an option 802 for a user to declare that the user is having trouble breathing. Option 802 may include, for example, a pictogram of an oxygen mask. Selection of option 802 may be routed to an on-duty nurse, doctor, or other caregiver using an instance of caregiver application 116. Option 802 may generate similar communication as option 712.

View 800 may include an option 804 for a user to declare that the user is hungry. Option 804 may include, for example, a pictogram of a plate and utensils. Selection of option 804 may be routed to an on-duty nurse, nurse's aid, or other caregiver using an instance of caregiver application 116. Option 804 may implement or may generate similar communication as option 510. Selection of option 804 may cause additional options to be displayed, such as those within view 830. View 830 may summarize the selections made thus far, such as an indication that the patient is hungry. View 830 may include an option 832 for the user to communicate that the user wants a snack or is slightly hungry. Option 832 may include, for example, a pictogram of a small amount of food, candy, crackers, or other suitable image. Furthermore, view 830 may include an option 834 for a user to declare that the user is ready for a meal. Option 834 may include, for example, a pictogram of a plate of food. View 830 may include an option 836 that the user wants ice. Option 836 may include, for example, a pictogram of a glass of ice.

View 800 may include an option 808 for a user to declare that the user is cold. Option 808 may include, for example, a pictogram of a thermometer that is blue or has a low reading. Selection of option 808 may be routed to an on-duty nurse, nurse's aid, or other caregiver using an instance of caregiver application 116.

View 800 may include an option 810 for a user to declare that the user is hot. Option 810 may include, for example, a pictogram of thermometer that is red or has a high reading. Selection of option 810 may be routed to an on-duty nurse, nurse's aid, or other caregiver using an instance of caregiver application 116.

View 800 may include an option 812 for a user to declare that the user feels poorly or badly. Selection of option 808 may be routed to an on-duty nurse, nurse's aid, or other caregiver using an instance of caregiver application 116.

View 800 may include an option 814 for a user to declare that the user is feeling feverish. Option 814 may include, for example, a pictogram of thermometer that is red or has a high reading. Selection of option 814 may be routed to an on-duty nurse, doctor, or other caregiver using an instance of caregiver application 116.

View 800 may include an option 816 for a user to declare that the user is feeling worse, an option 818 for a user to declare that the user is feeling better, or an option 820 for a user to declare that the user is feeling the same. Selection of one of these options may be routed to an on-duty nurse, doctor, or other caregiver using an instance of caregiver application 116.

View 800 may include an option 822 for a user to declare that the user is thirsty. In one embodiment, selection option 822 may be handled according to the selection of option 908, described below. Option 822 may include, for example, a pictogram of glass of water or a glass of ice. Selection of option 822 may be routed to an on-duty nurse, nurse's aid, or other caregiver using an instance of caregiver application 116.

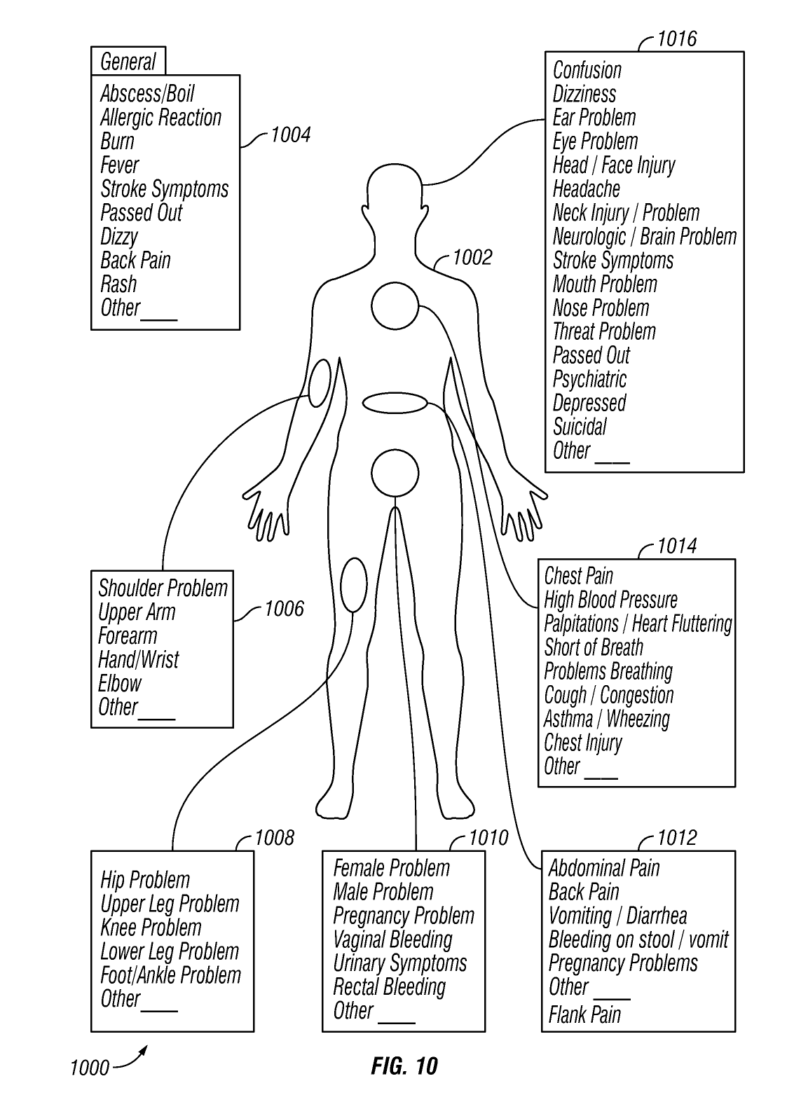

View 800 may include an option 824 for a user to declare that the user is feeling pain. Option 822 may include, for example, a pictogram of pain radiating from an appendage of a person. Selection of option 822 may be routed to an on-duty nurse, on-duty doctor, assigned doctor, or other caregiver using an instance of caregiver application 116. Selection of option 824 may cause additional options to be displayed, such as those within view 838. View 838 may summarize the selections made thus far, such as an indication that the patient is in pain. View 838 may include an option 840 for the user to communicate a level of pain that the user is experiencing. Option 840 may include, for example, a sliding scale from one to ten. Furthermore, selection of a pain scale in option 840 or pain in general in option 824 may cause a body map option 842. Body map option 842 may be configured to display any suitable image or map of a person's body for the patient to input where the pain is located. Such a body map option 842 may be shown in greater detail in conjunction with FIG. 10, below.

View 800 may include an option 826 for a user to declare that the user is experiencing nausea. Selection of option 822 may be routed to an on-duty nurse, on-duty doctor, assigned doctor, or other caregiver using an instance of caregiver application 116. Selection of option 822 may cause a further option 844 to prompt the user to indicate whether vomiting has occurred. Furthermore, selection of option 822 may cause prompting for a user to indicate a severity of nausea.

View 800 may include an option 828 for a user to declare that the user is experiencing dizziness. Option 828 may include, for example, a pictogram of a person's head with one or more criss-crossing rings around the person's head. Selection of option 828 may be routed to an on-duty nurse, on-duty doctor, assigned doctor, or other caregiver using an instance of caregiver application 116. Furthermore, selection of option 828 may cause prompting for a user to indicate a severity of dizziness.

View 800 may include an option 829 for a user to declare that the user is experiencing blood pressure problems. Option 829 may include, for example, a scale for blood pressure indicating that the blood pressure is too high or too low. Selection of option 829 may be routed to an on-duty nurse, doctor, or other caregiver using an instance of caregiver application 116.

View 800 may include an option 831 for a user to declare that the user is experiencing blood sugar problems. Option 831 may include, for example, a scale for blood sugar indicating that the blood pressure is too high or too low. Selection of option 831 may be routed to an on-duty nurse, doctor, or other caregiver using an instance of caregiver application 116.

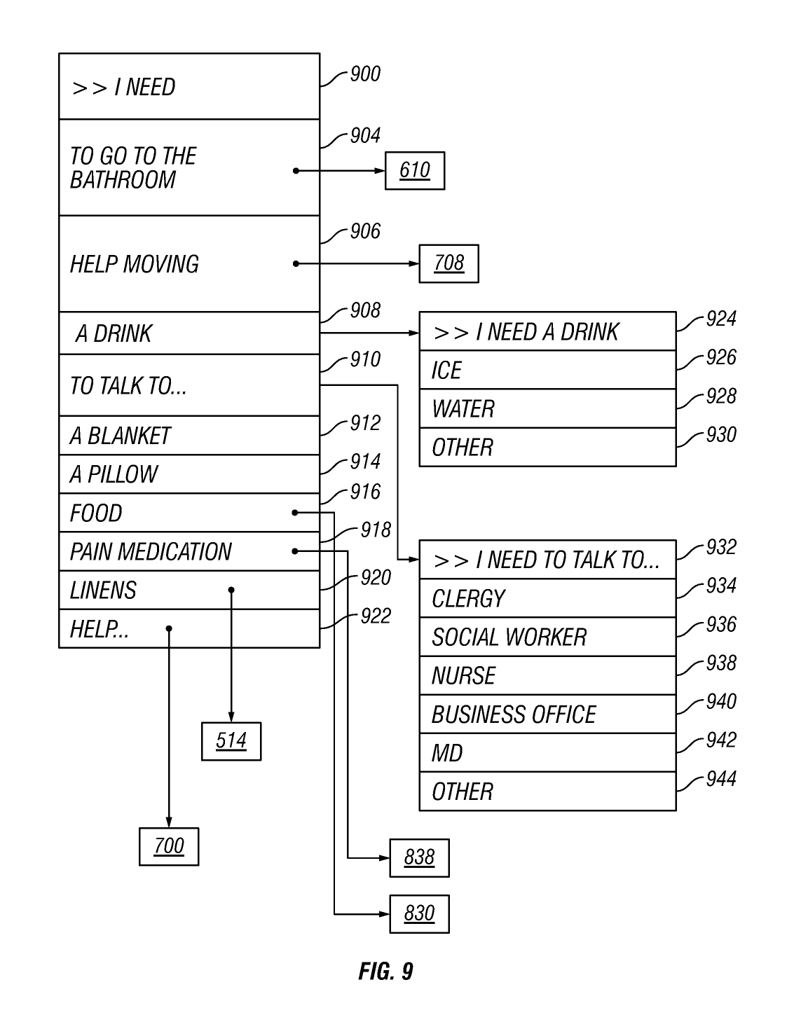

FIG. 9 illustrates an example embodiment of a view 900 including options for a user to indicate needs. View 900 may illustrate further operations derived from selection of option 506 from view 500. In one embodiment, view 900 may illustrate operations derived from selection of option 716 from view 700. In particular, view 900 may illustrate further options for a user to declare that the user needs something. Selection of an option within view 900 may be handled by patient application 108 by concatenating, evaluating, or logically combining the selections to form a single message to a caregiver through an instance of caregiver application 116. Furthermore, if an option is not selected within a given time period, patient application 108 may send a message with base information representing selections made thus far.

For example, view 900 may include an option 904 for a user to declare that the user needs to go to the restroom. Option 904 may be implemented in similar fashion in configuration, appearance, and operation as option 610.

View 900 may include an option 906 for a user to declare that the user needs help moving. Option 906 may be implemented in similar fashion in configuration, appearance, and operation as option 708.

View 900 may include an option 908 for a user to declare that the user needs a drink. Option 908 may include, for example, a pictogram of a glass of liquid. Selection of option 908 may be routed to an on-duty nurse, nurse's aid, or other caregiver using an instance of caregiver application 116. Selection of option 908 may cause additional options to be displayed, such as those within view 924. View 924 may summarize the selections made thus far, such as an indication that the patient needs a drink. View 924 may include an option 926 for the user to request ice (which may be represented by a pictogram of a glass of ice); an option 928 for the user to request water (which may be represented by a pictogram of a glass of water); or an option 930 for the user to request another kind of drink, such as coffee (which may be represented by a pictogram of a coffee cup.

View 900 may include an option 910 for a user to declare that the user needs to talk to someone. Option 910 may include, for example, a pictogram of a person speaking Selection of option 910 may be routed to an on-duty or assigned nurse, doctor, or other caregiver using an instance of caregiver application 116, or an administrator using an instance of admin application 112. Selection of option 908 may cause additional options to be displayed, such as those within view 932. View 932 may summarize the selections made thus far, such as an indication that the patient needs to talk to someone. View 932 may include an option 934 for a user to request to speak with a clergy member. A designated, on-duty, or on-call clergy member matched from the user's PHR profile may be selected and contacted. Option 934 may include, for example, a pictogram of clergy symbols or symbols of different religious faiths. View 932 may include an option 936 for a user to request to speak with a social worker or case worker. Such designated, on-duty, or on-call person matched from the user's PHR profile may be selected and contacted. View 932 may include an option 938 for a user to request to speak with a nurse. An on-call or on-duty nurse may be messaged. View 932 may include an option 940 for a user to request to speak with a business office or hospital administrator. An appropriate person may be messaged. Furthermore, view 932 may include an option 940 for a user to request to speak with someone else. Options may be presented for entering a person so-desired, such as a drop-down list or a free text box.

View 900 may include an option 912 for a user to declare that the user needs a blanket. Furthermore, view 900 may include an option 914 for a user to declare that the user needs a pillow. These options may include, for example, a pictogram of the requested object. Selection of these options may be routed to an on-duty nurse, nurse's aid, or other caregiver using an instance of caregiver application 116.

View 900 may include an option 918 for a user to declare that the user needs pain medication. Option 918 may be implemented in similar fashion in configuration, appearance, and operation as option 838.

View 900 may include an option 920 for a user to declare that the user needs linens. Option 906 may be implemented in similar fashion in configuration, appearance, and operation as option 514.

View 900 may include an option 922 for a user to declare that the user needs help, generally. Option 922 may be implemented in similar fashion in configuration, appearance, and operation as view 700.

FIG. 10 illustrates a body map 1000 configured to provide a patient the ability to indicate where symptoms, such as pain, are appearing. Body map 1000 may be configured to be used in conjunction with any suitable portion of system 100, such as with patient application 108 for communicating to a caregiver while in the hospital, for a patient to provide pre-triage information when en-route to a medical facility using patient application 108, or in conjunction with EMS application 120 to provide information en-route to a medical facility.

Body map 1000 may be selectable and interactive, such that selection of a portion of the body in body map 1000 may yield a list of one or more possible specific problems or pain locations. Each such list may be templatized, selectable, contain follow-on options or questions, or contain free-text forms. For example, option 1004 may provide a list of general malaises, problems, or symptoms. Option 1006 may provide possible symptoms associated with arms, shoulders, and hands. Option 1008 may provide possible symptoms associated with hips, legs, or feet. Option 1010 may provide possible symptoms associated with genitalia, reproductive systems, or excretory systems. Option 1012 may provide possible symptoms associated with the back or intestinal, digestive, or lower-torso systems. Option 1014 may provide possible symptoms associated with chest, heart, or lung systems. Option 1016 may provide possible symptoms associated with the head, brain, neck, eyes, ears, or throat, or mental conditions.

Returning to FIG. 4, in one embodiment, caregiver communication module 412 may determine to which caregivers of system 100 that inputted information will be sent. For example, a user of patient application 108 may designated a specific caregiver or no specific caregiver. However, a specified caregiver may be unavailable. Therefore, caregiver communication module 412 may present inputted information in conjunction with a selectively edited portion of the PHR to a caregiver who is, for example, on-call to receive such communication.

Caregiver communication module 412 may be implemented in conjunction with other modules, such as teaching module 420, outpatient module 422, and inpatient module 426. For example, a user of patient application 108 may utilize caregiver communication module 412 while performing healthcare related activities using these modules. The appearance of displays used with caregiver communication module 412 may be selectively adapted according to an inpatient, outpatient, or teaching use. For example, during inpatient or outpatient use, displays used with caregiver communication module 412 may use logos, pictograms, or other images for a patient to communicate with a caregiver. In another example, during teaching mode, displays may include feedback or communication concerning content that is to be viewed.

Medical test module 416 may be configured to provide information about medical tests that have been ordered, conducted, or analyzed for a user of patient application 108. Individual ones of such tests may be selected in patient application 108 for presentation, visualization, or educational information regarding the test. Medical test module 416 may be configured to determine such information from a PHR, for example. In one embodiment, medical test module 416 may be configured to only selectively display medical test information that has been authorized for release by a caregiver. For example, a doctor may have ordered tests but may wish to personally inform a user of patient application 108 about such tests, rather than have a user of patient application 108 learn about the tests for the first time by accessing medical test module 416. In another example, test results may have been received but may not have been analyzed. In yet another example, test results may have been received but a doctor may wish to personally inform a user of patient application 108 about such results.

Furthermore, medical test module 416 may be configured to present results from tests in a fashion organized by recent tests, such as tests within a previous day, week, or month period, with options to expand to views of tests within previous ranges. Medical test module 416 may be configured to index tests by a name of a test and provide options for finding out general information about the kind of test conducted, seeing the specific results, and selectively forwarding them to another user of system 100.

Paperwork module 418 may be configured to present and allowing modification of various forms for a user of patient application 108. Paperwork module 418 may be configured to, for example, provide facility-specific or other document templates, allow insertion of information, allow pictures or files to be submitted. Paperwork managed by paperwork module 418 may include, for example, photographs taken by a user of patient application 108, general documents uploaded by a user of patient application 108, legal forms, lab tests, admission notes, discharge summaries, consultation notes, operation notes, and notes from specialists organized by field. Paperwork module 418 may be configured to allow each such paperwork element to be viewed or selectively forwarded to another user of system 100.

Teaching module 420 may be configured to present educational, medical information to a user of patient application 108. Such information may be determined by a caregiver of a user of patient application 108. For example, a caregiver of a user of patient application 108 may direct the patient to view certain videos, read certain information, or listen to certain audio transmissions. Teaching module 420 may track whether a user of patient application 108 has reviewed such information and answered certain follow-up questions, quizzes, or other mechanisms for affirming understanding. Teaching module 420 may inform a caregiver if a user of patient application 108 has not viewed required information in a specified time frame. Previously viewed content may be designated as such and be available for perusal at a later time.

Outpatient module 422 may be configured to selectively present information and communication for a user of patient application 108 to conduct healthcare-related tasks after discharge from a healthcare facility. Outpatient module 422 may be implemented in conjunction with, for example, caregiver communication module 412. A caregiver may communicate instructions, information, or questions to a user of patient application 108 after a procedure, stay at a healthcare facility, or a visit to a healthcare facility. Such communication may be transmitted using secured electronic communication such as text, instant message, or a proprietary format. Such communication may be handled and presented by outpatient module 422. Outpatient module 422 may display communication between a user of patient application 108 and a caregiver in a chat format, wherein a history of the dialogue may be presented. Furthermore, outpatient module 422 may present such communication on a caregiver-by-caregiver basis, facility-by-facility basis, or a suitable combination of the two. Outpatient module 422 may include an interface for a user of patient application 108 to enter communication as presented by interface 508. Furthermore, outpatient module 422 may include options to call a caregiver assigned to or on-call for an outpatient incident. In addition, outpatient module 422 may include options to record or listen to voice clips, or to take pictures with an electronic device upon which patient application 108 is operating.

Some messages may be sent to patient automatically using outpatient module 422 after discharge from a facility. Such messages may include inquiries from caregivers regarding patient condition. Inquiries to be sent as well as responses may be routed to on-call or on-duty personnel to facilitate response in timely fashion. Messages may be formulated using templates to build sentences to describe current symptoms, conditions, replies, and ordering of prescriptions.

Login module 424 may be configured to log a user of patient application 108 into patient application 108 or to system 100. In one embodiment, login module 424 may include mechanisms for logging in with a username and password. In another embodiment, login module 424 may include scanning mechanisms to scan a user's credentials to verify information and log in to system 100. For example, a user of patient application 108 may have a card, bracelet, or other mechanism with a QR code, barcode, RFID chip, fingerprint, facial recognition, or other information source. An electronic device upon which patient application 108 is operating may include a scanner, camera, reader, or other mechanism for reading the information source. Login module 424 may be configured to create accounts or retrieve lost passwords.

Inpatient module 426 may be configured to selectively present interfaces to a user of patient application 108 based upon such a user's stay in a healthcare facility. The selectively presented interface may include communication options that are specific to, for example, a skilled nursing patient, a patient staying in a hospital or a patient recovering from outpatient surgery in a facility. Inpatient module 426 may be implemented with a selective set of communication as illustrated in caregiver communication module 412 and features associated with outpatient module 422.

Vitals module 428 may be configured to provide one or more vital medical statistical data points of a user of patient application 108. Such information may be included in a PHR or otherwise provided to a caregiver user of system 100 when such information is pushed, for example, as part of an en-route operation in association with emergency en-route module 406. Information for vitals module 428 may be input by a user of patient application 108, a device used by a user of patient application 108, or any other suitable manner. Vitals module 428 may be configured to generate graphs or historical vital sign data to send to a caregiver or other party track progress. Furthermore, vitals module 428 may be configured to provide vitals alerts to a user, which may indicate that a user is to take specific vitals at specific time of day to track progress. After input of values, vitals module 428 may be configured to alert a user or automatically send a message to a caregiver if the vitals appear outside of acceptable ranges. Medication module 430 may include a record, reminder, or other indication of medicines to be taken by a user of patient application 108. Based upon medications prescribed by one or more caregivers of system 100, medication module 430 may be configured to remind a user of patient application 108 to take medications.

Dietary module 432 may include an indication of menu options that may be available for a user of patient application 108 to select while in a healthcare facility such as a hospital. Dietary module 432 may be configured to selectively present a subset of menu choices available from the facility. To make such a selective presentation, dietary module 432 may be configured to access medical information from the patient's PHR to determine dietary restrictions and requirements, such as sodium, fat, carbohydrate, calories, special-needs, or allergies. Furthermore, dietary module 432 may be configured to determine the dietary content of various menu options available at the facility. Dietary module 432 may be configured to cross-reference the patient's dietary restrictions and requirements with available menu choices. Based on such a cross-reference, dietary module 432 may be configured to selectively display available menu choices to the patient that match the dietary restrictions and requirements. Menu choices violating the dietary restrictions and requirements, alone or in combination with other selected menu items, may be hidden. Furthermore, menu choices required by dietary restrictions and requirements may be included in a selection by default. A user of patient application 108 may select the menu choices presented in dietary module 432, which may communicate an order to a portion of system 100 configured to alert the preparation of the menu selection and route the selection for delivery to the patient's location.

Links module 434 may be configured to determine one or more network destinations, web sites, or applications available for more information or additional functionality for a user of patient application 108. Links module 434 may be configured to present such information to a user of patient application 108 within any suitable context of patient application 108.

Furthermore, outpatient module 422 may include an option to select to talk to a caregiver face-to-face regarding follow-up information, medication, vitals, or other medical information. Such an option may be configured to set a preference that the user prefers face-to-face communication. The option may also be configured to notify the user that such communication may not be as timely as other communication, such as messaging.

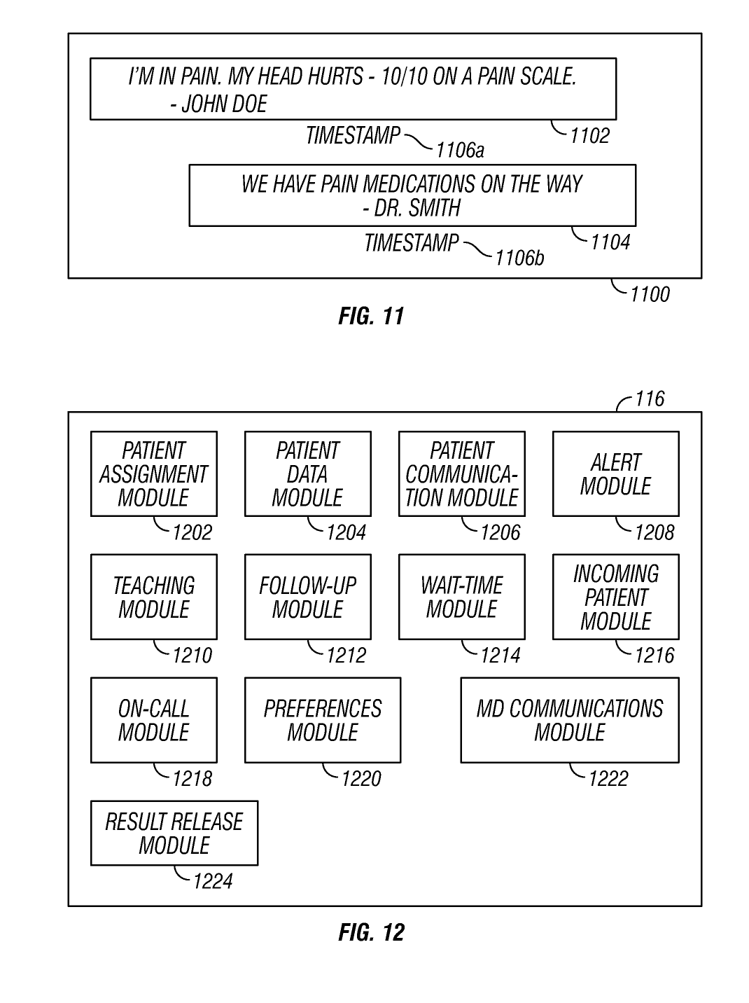

FIG. 11 illustrates an example embodiment of a conversation view 1100. Conversation view 1100 may illustrate the result of entering communication between an instance of patient application 108 and an instance of caregiver application 116. Conversation view 1100 may be implemented in any suitable way, such as by a display illustrating different elements of communication from each party. Conversation view 1100 may be implemented in any suitable portion of, for example, patient application 108, EMS application 120, or caregiver application 116. Conversation view 1100 may display secured messages that have been sent between different users of system 100.

In the example of FIG. 11, a communication 1102 may be constructed by, for example, a patient entering various templatized values or free text in patient application 108 as described above. Furthermore, communication 1102 may include a timestamp 1106a. In response to communication 1102, another communication 1104 may have been constructed and sent by a caregiver using caregiver application 116. Communication 1104 may also include a timestamp 1106b. Communication 1104 may be positioned in relation to communication 1102 to indicate that communication 1104 has occurred at a later time.

The contents of conversation view 1100 may be stored by system 100. The storage of conversation view 1100 may be stored according to the patient associated with the contents of conversation view 1100. In one embodiment, the contents of conversation view 1100 may be between a patient and one or more caregivers. In another embodiment, the contents of conversation view 1100 may be between two or more caregivers. In such an embodiment, even though the patient is not a party to the conversation, the contents of conversation view 1100 may be stored in association with the patient. Thus, contents of conversation view 1100 may be accessible through access of the patient's PHR.

Consequently, multiple instances of conversation view 1100 may exist simultaneously on different applications, such as caregiver application 116 or patient application 108. Such multiple instances may relate to the same patient. A caregiver or a patient may be presented with a choice of such instances of conversation view 1100 from which to choose, or may be presented with the choice of initiating a new instance of conversation view 1100.

Furthermore, in a given instance of conversation view 1100, an option may be presented to terminate or close out a conversation. Such an option may be implemented by, for example, a separate, explicit option or by an option for a response that inherently terminates the conversation. For example, an option for a response by a caregiver that a requested medication is on the way may terminate a conversation.

If the contents of a conversation view 1100 are updated after period of time, system 100 may send an alert updating suitable parties through, for example, instances of caregiver application 116 or patient application 108. A user of patient application 108 involved in a previous conversation may be alerted if another party updates the conversation. System 100 may determine whether previous one or more participants of the conversation are still actively using system 100, or whether another participant should be alerted instead. For example, a patient may update a conversation with a caregiver, but the caregiver may no longer be on duty. In such a case, system 100 may select a caregiver who is on-call or on-duty and present the entire communication to the caregiver.

FIG. 12 illustrates an example embodiment of caregiver application 116. Caregiver application 116 may include any suitable number of modules, interfaces, and displays to perform the operation as described herein. Each module may be implemented by any suitable combination of code, logic, applications, scripts, functions, executables, firmware, input/output mechanisms, displays, views, software, or hardware. Specific instances of caregiver application 116 may be selectively adapted for a category of caregiver, such as a nurse, doctor, specialist, EMT, or other healthcare professional.

For example, caregiver application 116 may include a patient assignment module 1202, patient data module 1204, patient communication module 1206, alert module 1208, teaching module 1210, follow-up module 1212, wait-time module 1214, incoming patient module 1216, on-call module 1218, preference module 1220, MD communication module 1222, and a result release module 1224. Each such module may be associated with one or more user screens configured to provide input and output to a user of caregiver application 116.

Patient assignment module 1202 may be configured to allow a user of caregiver application 116 to assign patients of system 100 to various caregivers. Such assignment may be made within a given healthcare entity. Patient assignment module 1202 may be configured to provide a mechanism to select the healthcare entity, such as a hospital or doctor's office. For a given entity, patient assignment module 1202 may be configured to display available, unassigned patients. The view of available patients may be filtered by, for example, patients who have notified the entity that they are on their way, patients in emergency, or patients who have been discharged. Furthermore, the view may be filtered based upon physical location such as room, unit, wing, floor, or building. Patient assignment module 1202 may be configured to allow a user to drag and drop or otherwise add a patient from an available list to a list of patients assigned to the user. Furthermore, patient assignment module 1202 may be configured to similarly allow a user to remove a patient from a list of patients assigned to the user to the list of available patients. Patient assignment module 1202 may be configured to provide searching by name for patients. Patient assignment module 1202 may be configured to allow a user to forward all patients. Thus, the patients assigned to the user may be forwarded to a designated on-call caregiver. Patients may be forwarded using a binary on/off designation, and may be forwarded to an identified on-call caregiver. Similarly, patient assignment module 1202 may be configured to indicate to an on-call caregiver a list of patients who have been forwarded. Such patients may be forwarded to yet another caregiver, such as another on-call caregiver or a specialist, or returned to a caregiver who originally was assigned the patient. Patient assignment module 1202 may be configured to record any such assignment. Such assignments may be recorded to a PHR.

Patient data module 1204 may be configured to display to a user of caregiver application 116 information about one or more patients assigned to the caregiver. Such an assignment may have been made, for example, using patient assignment module 1202. Patient data module 1204 may include a mechanism for selecting an assigned patient or searching available patients. Information, such as that from a PHR for the patient or information uploaded from an EMR, may be selectively displayed.

Patient communication module 1206 may be configured to provide communications for a user of caregiver application 116 to a patient or to other caregivers about a patient. New messages received from patients or other caregivers about patients may be displayed on a per-patient basis. A tabular display or other mechanism may be used to organize separated views of such information on a per-patient basis. Information may be received via text or secured electronic transmission. Such information, as received from patients, may be in templatized form from patient application 108. For a given per-patient view, patient communication module 1206 may display the previous received and sent messages. Furthermore, patient communication module 1206 may include a mechanism for displaying a PHR, viewing test results, medical history, and current medications. In addition, patient communication module 1206 may be configured to provide a shortcut or one-button click to call the room of the patient.

Patient communication module 1206 may include submodules for replying to a patient or communicating with another caregiver. For replying to a patient, patient communication module 1206 may include templatized input or allow free response. Furthermore, patient communication module 1206 may be configured to access the status in system 100 of previously issued orders, such as prescription orders. Patient communication module 1206 may be configured to allow the caregiver to make recorded notes by, for example, typing or voice, based on the communication received. For communicating with another caregiver about a given patient, patient communication module 1206 may be configured to present a list of caregivers, such as doctors or nurses, to whom the communication should be addressed. Furthermore, patient communication module 1206 may be configured to allow a user to forward communication from the patient to the selected caregiver. Patient communication module 1206 may be configured to allow a user to order medications, housekeeping, medical tests, adjust rounds, or obtain paperwork by communicating with another caregiver.

Alert module 1208 may be configured to provide templatized just-in-time medical diagnosis and procedure information to a user of caregiver application 116 based on a given patient's condition. Any suitable set of procedures, checklists, diagnosis charts, or other information may be included. Alert module 1208 may be configured to prompt a user of caregiver application 116 to enter information as observed, conditions checked, or other information that may be unavailable from system 100. Based on the PHR and input from the user of caregiver application 116, alert module 1208 may be configured to guide the user to a diagnosis, next step to take, or additional information to gather to facilitate the treatment of the patient. Alert module 1208 may refer to any suitable set of rules, heuristics, decision trees, care documents, thresholds, recommendations, requirements, exceptions, or other reference data to determine such courses of action to recommend. Such reference data may be updated regularly. In one embodiment, such reference data may include core measures as set by joint medical commissions.

Teaching module 1210 may be configured to allow a user of caregiver application 116 to designate educational, medical information to a designated patient. The patient may view such information, for example, through teaching module 420. For example, a caregiver using caregiver application 116 may direct the patient to view certain videos, read certain information, or listen to certain audio transmissions. Teaching module 1210 may be configured to send such information to the intended recipient and track whether a patient has reviewed such information and answered certain follow-up questions, quizzes, or other mechanisms for affirming understanding. Teaching module 1210 may be configured to inform a user if a user of system 100 has not viewed required information in a specified time frame. Teaching module 1210 may be configured to allow searching of available content. Furthermore, teaching module 1210 may be configured to transmit follow-up checks to a patient after, for example, a delay after a discharge of the patient.

Follow-up module 1212 may be configured to manage and perform follow-up communication between a caregiver and a patient that was previously cared for by a caregiver in system 100. Follow-up module 1212 may include multiple views of patients that may be serviced through outpatient or follow-up medical advice. One such view may include patients assigned to a user of caregiver application 116. Another such view may include unassigned patients in need of follow-up. Yet another such view may be configured to allow a user to initiate follow-up communications with a designated patient. In any given view, follow-up module 1212 may include options for viewing a profile, medical history, PHR, lab results, radiology reports, uploaded data from an EMR, medication lists, or other information about a patient. Furthermore, follow-up module 1212 may include an option for escalating a patient to another caregiver, such as a doctor, or for forwarding the follow-up information to another caregiver.

In one view including patients assigned to a user of caregiver application 116, follow-up module 1212 may be configured to display a list of the assigned patients. Such a list may include a brief summary of each patient including name, age, gender, and when the patient was dismissed. Furthermore, follow-up module 1212 may be configured to display a summary of messages sent to and from the patient. Such a display may be presented in tabular format, for example, to separate the conversations with each patient. Each tab or the list of assigned patients may include a designation of newly received communications as well as an indication of a number of waiting messages. A conversation view with each patient may include a history of messages sent to and from the patient.

In another view for unassigned patients, follow-up module 1212 may display a list of unassigned patients and an indication of a number of messages received from the patient. Follow-up module 1212 may be configured to allow a user to select an unassigned patient and assign the patient to the user or to another designated caregiver. Such configuration may allow a patient to be assigned to an on-call or on-duty caregiver at all times. Consequently, a message received from a patient to a caregiver who is now off-duty may be received by an on-duty caregiver, along with the context of the previous conversation. The on-duty caregiver may be able to respond correctly to the patient's message.

In yet another view, follow-up module 1212 may be configured to allow a user to create a new patient to be included in follow-up communications. Such creation may occur at, for example, discharge of the patient from a facility or upon completion of a visit or procedure. Follow-up module 1212 may include options for selecting a facility, patient, and a number of days after discharge to trigger a follow-up. The follow-up may be automatically sent to the patient using, for example, text, SMS, or a secured electronic message to a user of a patient application 108. The reminder may include, for example, information about medication, rehabilitation, or educational information.

Wait-time module 1214 may be configured to display, for a selected facility, wait times for patients. Such wait times may be determined by determining the number of patients waiting in the facility, the triage information about such patients, the staffing levels of the facility, the number of patients on their way or en-route to the facility, and scheduled arrivals of other patients. Such information may be harvested from system 100. The estimated times may be given according to a sub-category, such as emergency care, urgent care, or minor care. Furthermore, wait-time module 1214 may be configured to display statistics for a given period, such as total visits, patients checked in the last hour or the last three hours, number of admissions to the facility, total number of emergency beds available, and total number of facility beds available. Such information may be harvested from system 100. In one embodiment, such information may be configured to be displayed to a user of patient application 108. Such information may be displayed, for example, in conjunction with a patient selecting a facility to which the patient is en-route.

Incoming patient module 1216 may be configured to manage information regarding patients that are incoming to a health facility or have arrived and are awaiting healthcare service. Incoming patient module 1216 may include one or more views for communication with an EMS service. Such an EMS service may be using EMS application 120. The view of EMS communication may include sequences of messages sent between the user of caregiver application 116 and the EMS service. Such messages may be displayed in a conversation record. The messages may include text, SMS, or other secured electronic messages. Furthermore, voice, video clips, or streaming video may be transmitted between the user of caregiver application 116 and the EMS service and markers for such clips may appear on the conversation display. The view may include an indication of the estimated time of arrival; the name, age, and gender of the patient; a link to the patient's PHR; an identification of the EMS service unit; or special medical information or statuses initiated by the EMS service, such as whether certain procedures have been started. Incoming patient module 1216 may include options for a user to acknowledge reception of a message, make a templatized or free text reply, record a voice clip for a PHR or for reply to an EMS service, or sending information to another caregiver. Furthermore, incoming patient module 1216 may include options for informing system 100 that a designated inbound patient has arrived. Incoming patient module 1216 may include options for removing an EMS transmission from the view.

Incoming patient module 1216 may be configured to determine a location of all incoming patients by GPS or similar information. The mode of transport of each such patient may be determined. The estimated time of arrival, based on, for example, the location of the incoming patient and the mode of transport may be determined. Furthermore, the determined location, estimated time of arrival, and method of arrival of each such patient may be displayed in a map.

Similar to or in conjunction with an EMS view, incoming patient module 1216 may include a view of pre-triage information for a designated patient. Such information may be provided by, for example, an EMS service through EMS application 120 or a patient through patient application 108. Such a view may include details about the condition of a patient that is en route to the facility. The view may include the name, age, and gender of the patient and a link to the patient's PHR. Furthermore, if the patient has arrived or checked in, the view may note the times of such actions. Such information may be harvested from the operation of system 100. Incoming patient module 1216 may include options to designate a patient as arrived or checked-in. Furthermore, incoming patient module 1216 may include options for removing the patient if the patient is being treated, or delaying the patient if conditions warrant.

Furthermore, incoming patient module 1216 may include a view of patients waiting at a healthcare facility for treatment or meeting with a caregiver. Such a view may display such patients that have arrived and checked in to the facility using, for example, patient application 108. The view may include a representation of the arrival time, check-in time, or other information for each patient. Incoming patient module 1216 may be configured to provide patient demographics, links to each patient's PHR, links to previous communication with caregivers at the healthcare facility, or other suitable information. Furthermore, incoming patient module 1216 may be configured to allow a user to change a status of a patient to being moved to a specified location or room, remove a patient from the list, or forward information to another healthcare provider.

In addition, incoming patient module 1216 may be configured to communicate with all or a subset of the patients with a waiting status via message. Such a message may be delivered to, for example, all waiting patients or patients within a specific category of patients.

On-call module 1218 may be configured to provide information about the on-call status of caregivers for a given facility or entity. Such on-call information may be harvested from the operation of system 100. The on-call information may be divided between types of caregivers (such as nurses or doctors), practice specialties, consultants, geographic divisions (such as floor or wing), or facility or entity. Furthermore, on-call module 1218 may include options for a caregiver to select to enter or leave an on-call status, and view patients that are to be added or removed from responsibility. Options for entering on-call status may include a binary selector for the caregiver herself to enter or exit on-call. Furthermore, the options may include an option to selectively choose another caregiver as a recipient of forwarded on-call calls. In addition, on-call module 1218 may include options for specifying a group of caregivers who are all on-call together. In such situations, each such doctor may receive a call for the on-call group. In one embodiment, on-call module 1218 may be configured to disallow a caregiver to remove on-call responsibility until another caregiver accepts on-call responsibility. Such responsibility may include the listing of the specific patients under on-call supervision. On-call module 1218 may be configured to prevent a patient within a given geographic, health status, or other division from being without a caregiver for one or more pluralities of on-call service. For example, a patient in a room at a hospital may be assigned to an on-call nurse and on-call hospitalist doctor by on-call module 1218; on-call module 1218 may then be configured to disallow the on-call nurse to remove their on-call status concerning the patient without assignment of the patient and the on-call status to another nurse. Similarly, on-call module 1217 may be configured to disallow the on-call hospitalist to remove their on-call status concerning the patient without assignment of the patient and the on-call status to another hospitalist. The changeover of on-call assignments may be recorded in the patient's PHR.

Preferences module 1220 may be configured to establish, change, or otherwise manage a user's contact information, preferred name, biography, e-mail address, password, or credentials.

MD communication module 1222 may be implemented in similar fashion to patient communication module 1206, but may be configured to provide additional functionality for caregiver-to-caregiver communications. Such functionality may include, for example, physician-to-physician communication, nurse-to-physician communication, physician-to-EMS communication, or nurse-to-nurse communication. MD communication module 1222 may include a view of patients currently assigned to a caregiver, similar to views presented in patient assignment module 1202 or patient data module 1204. MD communication module 1222 may include options for calling, messaging with templates, or otherwise contacting another caregiver or a director of a healthcare facility directly

Furthermore, MD communication module 1222 may include a view of consultations. Such consultations may be made between two or more caregivers to collaborate on diagnosis, treatment, or other healthcare issues of a given patient. A consultation may be stored as a self-contained or compartmentalized aspect of a PHR or other data structure of system 100. The consultation view may include options for creating a new consultation with one or more other caregivers. The options for creating a new consultation may include a feature for selecting a consultation subject, such as a newly admitted patient, a patient recovering from a treatment or procedure, a proposed treatment or procedure for a patient, or other healthcare topic. Furthermore, the options for creating a new consultation may include a feature for selecting a time frame and a feature for selecting a location in which the consultation should take place. In addition, a feature may be included for specifying whether follow-up with the requesting caregiver is required, optional, necessary before the consultation, or necessary after the evaluation. A feature may be included giving an initial diagnosis. Furthermore, features may be included for attaching voice, video, free-text, or images made with a device powering MD communication module 1222 in relation to the consultation.

The view of consultations may also include a view of requested consultations and options for replying to such consultations. Possible consultations may be presented in text form, assembled by MD communication module 1222 from the options selected by a user thereof. Options may be provided for designating, from a list of choices, actions that will be taken in response to the requested consultation, such as whether admission, treatment, or other activities will be taken, and for which patient. Furthermore, options may be provided for responding that the user of MD communication module 1222 is not on-call or is otherwise unavailable to take the consultation. The request may be selectively forwarded to another caregiver. A selection of possible caregivers may be generated by MD communication module 1222, including, for example, caregivers using system 100 or caregivers with an active on-call status. Furthermore, the view of consultations may include a view for sending a callback request to another consulting caregiver.

In addition, MD communication module 1222 may include a view of messages received from other caregivers. Such messages may include proposed consultations or other messages. The view of messages may indicate a caregiver requesting the consultation, a timestamp, a referenced patient, and whether the message was delivered and read. Once a message is selected, a conversation window may be used to display messages sent and received between the caregivers. Messages may be forwarded to another caregiver using system 100 or to an on-call pool of caregivers. Each such selection may be made from an available list.

Also, MD communication module 1222 may include a view of messages that may be selectively displayed on a per-patient basis. Such messages may include a conversation display of messages to and from other caregivers regarding the given patient. Conversations may be selected by, for example, choosing a facility and choosing a patient from a list of available or assigned patients in such a facility.

Result release module 1224 may be configured to provide information about lab results, procedure results, or other treatment results for a given patient and provide features for selectively releasing the information to a user of patient application 108. In one embodiment, result release module 1224 may highlight lab results that are critical or sensitive to a user of caregiver application 116. For a given patient, a list of lab results may be presented. Shortcuts to communications modules, such as patient communication module 1206 or MD communication module 1222, may be presented in-line or in conjunction with a given result. Use of such a shortcut may pre-populate communication with another user of system 100 using patient application 108 or caregiver application 116 with the test results. Furthermore, options to release or not release a given result may be provided to the user of result release module 1224. Selection of no release may trigger result release module 1224 to schedule a follow-up conversation with the patient in question. Selection of release may permit viewing of the result on the PHR by the patient and may generate a text message that is sent to the patient via system 100. Furthermore, result release module 1224 may include options to release all results for a given patient, or to selectively release the results with comments to be entered by the user of result release module 1224.

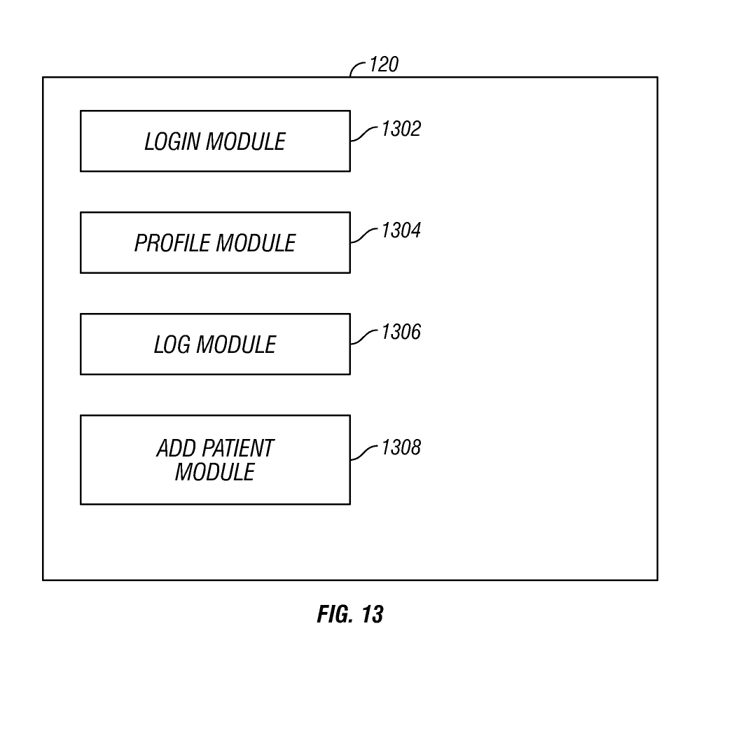

FIG. 13 illustrates an example embodiment of EMS application 120. EMS application 120 may include any suitable number, kind, or combination of components to perform the functionality described herein. For example, EMS application 120 may include a login module 1302, profile module 1304, log module 1306, and add patient module 1308. Each of login module 1302, profile module 1304, log module 1306, add patient module 1308, and other elements of EMS application 120 may be implemented by any suitable application, script, executable, logic, instructions, functions, hardware, software, firmware, input/output mechanisms, displays, views, or any suitable combination thereof.

Login module 1302 may be configured to provide the ability for a user, such as an EMT, to log in to EMS application 120 and, consequently, system 100. Login may be conducted in any suitable manner, such as by scanning of a QR code, username and password, personal identification number, or any combination thereof.

Profile module 1304 may be configured to allow a user of EMS application 120 to enter or view user information. Such information may include, for example, first and last name, photograph, identification number, and contact information.

Log module 1306 may be configured to track, record, or display a log of transported patients. Such information may be recorded from previous operation of EMS application 120. Information including, for example, patient identification number, age, gender, pick-up location, and destination location may be included for each such patient. Furthermore, each such patient entry may be retrievable to determine additional recorded data from the operation of EMS application 120, equipment used, notes or communication made, or other data associated with the patient. In addition, active patients currently in contact with a user of EMS application 120—for example, patients currently being transported—may be displayed separately from previously transported patients.

Add patient module 1308 may be configured to allow a user of EMS application 120 to add a patient upon pick-up, assistance, or other contact. A patient may be added, for example, by scanning a QR code of the patient to look the patient up in system 100, the patient logging in, or another release of the patient's information to system 100 and, specifically, to EMS application 120. Such a release may include a push of information from the patient's PHR to EMS application 120. In one embodiment, such a push of information may include a selective push of the information from the PHR. The selection of a patient to be added to EMS application 120 may be made from a list of possible patients.

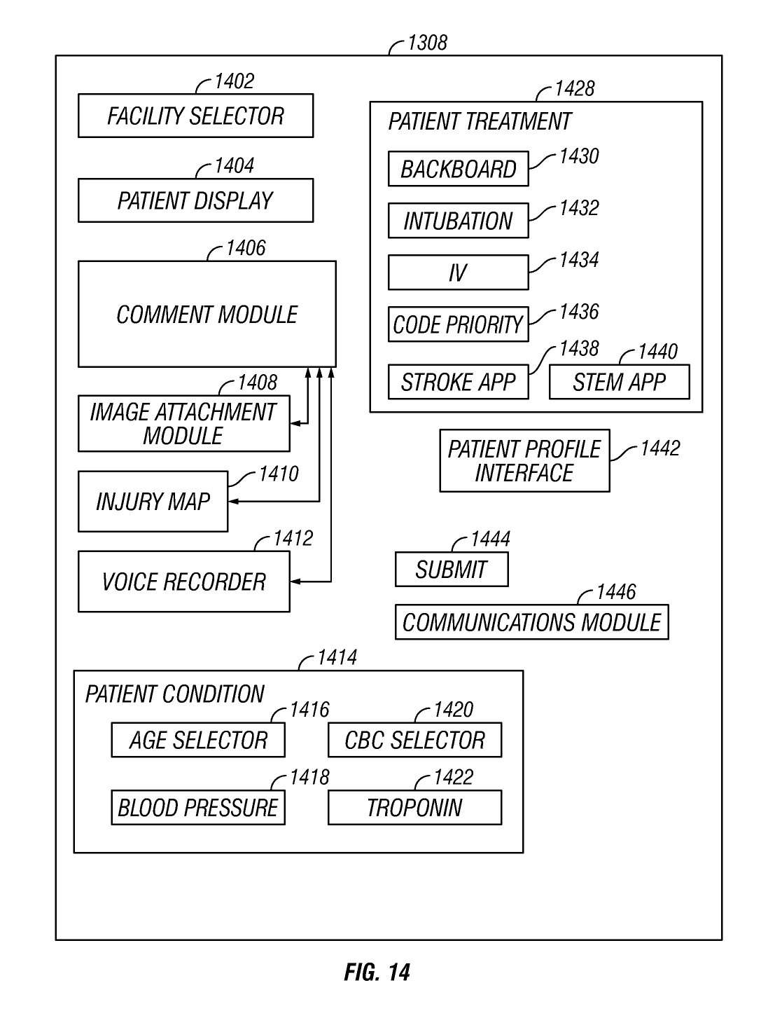

FIG. 14 is an illustration of an example embodiment of add patient module 1308 once a patient has been selected to be added to EMS application 120. Add patient module 1308 may include any suitable number, kind, or combination of components to perform the functionality described herein. For example, add patient module 1308 may include a facility selector 1402, patient display 1404, comment module 1408, injury map 1410, voice recorder 1412, patient condition module 1414, patient treatment module 1428, patient profile interface 1442, submit option 1444, and communications module 1446. Each of facility selector 1402, patient display 1404, comment module 1408, injury map 1410, voice recorder 1412, patient condition module 1414, patient treatment module 1428, patient profile interface 1442, submit option 1444, communications module 1446, and other elements of add patient module 1308 may be implemented by any suitable application, script, executable, logic, instructions, functions, hardware, software, firmware, inputs/outputs, views, displays, or any suitable combination thereof.

Facility selector 1402 may be configured to allow selective input and display of a facility to which a patient being treated will be transported. In one embodiment, a user of add patient module 1308 may select the facility. In another embodiment, the facility to which the patient will be sent may be determined by system 100 and pushed to EMS application 120. Such a determination may be based upon, for example, the condition of the patient, the symptoms of the patient, the time of the onset of the symptoms, the distance to a given facility, and the services, personnel, wait times, or equipment of the given facility.

Patient display 1404 may be configured to display information about the patient associated with use of EMS application 120. The information may include identifying information. In one embodiment, such information may be pre-populated from the push of information from the PHR from system 100 to EMS application 120, or from the receipt of such information directly from a sign-in of the patient.

Comment module 1406 may be configured to display pending communication or other information to be communicated from a user of EMS application 120. Comment module 1406 may include displays for text, icons representing additional data such as a voice clip or image, or any other suitable communication. Comment module 1406 may be communicatively coupled to other elements for inputting comments, such as image attachment module 1408, injury map 1410, or voice recorder 1412. Image attachment module 1408 may include mechanisms for attaching a photograph previously created or for taking a photograph with equipment on or coupled to the electronic device upon which EMS application 120 is executing. Injury map 1410 may include a stylized map of a person and provide options for a user of EMS application 120 to select which portion of a patient's body requires medical attention. Injury map 1410 may be implemented in similar fashion to body map option 842 as described above. Voice recorder 1412 may be configured to allow a user of EMS application 120 to record notes regarding the patient. Voice recorder 1412 may be implemented, for example, using features or equipment upon an electronic device upon which EMS application 120 is executing. The output of image attachment module 1408, injury map 1412, or voice recorder 1412 may be assembled and represented in comment module 1406. Comment module 1406 may include a keyboard input display or otherwise accept keyboard input to include free text.

Patient condition 1414 may include one or more inputs or outputs for indicating and recording the present condition of a patient. Such inputs may be configured to be set by a user of EMS application 120, automatically imported from a medical device, or obtained in any other suitable manner. In one embodiment, such inputs may be received and unalterable, and may be displayed only as outputs. Patient condition 1414 may include any suitable combination of inputs and outputs for setting or indicating the present condition of a patient. For example, patient condition 1414 may include an indicator 1416 for indicating the patient's age, an indicator 1418 for indicating the patient's blood pressure, an indicator 1420 for indicating the patient's complete blood count (CBC), and an indicator 1422 for indicating the patient's troponin level. Other conditions recorded, indicated, determined, or reported by patient condition 1414 may include electrocardiograph data, heart rate, blood sugar, or any other instantaneous patient wellness data. In one embodiment, one or more of the elements of patient condition 1414 may be entered by a user of EMS application 120. In another embodiment, one or more of the elements of patient condition 1414 may be gathered or determined by communication between EMS application 120 and one or more medical devices.

Patient treatment 1428 may include one or more inputs for indicating and recording treatments that have been applied to the patient. Such inputs may include options for entering or indicating use of backboard 1430, intubation 1432, or intravenous (IV) treatment 1434. Other inputs may include options for indicating the application of a number and kind of IV treatments, injections, pain medication applied, cardio-pulmonary resuscitation, or defibrillation. Furthermore, patient treatment 1428 may include an input for selecting a code priority 1436, indicating a severity or priority associated with the patient's condition. In addition, patient treatment 1428 may include or be communicatively coupled to one or more specialized application. Such specialized applications may include, for example, an application 1438 for entering detailed information about a stroke patient or an application 1440 for entering detailed information about a ST segment elevation myocardial infarction (STEMI) patient.

Patient profile interface 1442 may include any suitable mechanism for accessing, updating, or recording information to or from a PHR or other profile of the patient. Submit 1444 may include an option for a user of EMS application 120 for submitting the information collected in, for example, add patient module 1308 to system 100 and, more particularly, to a facility to which the patient will be transported.

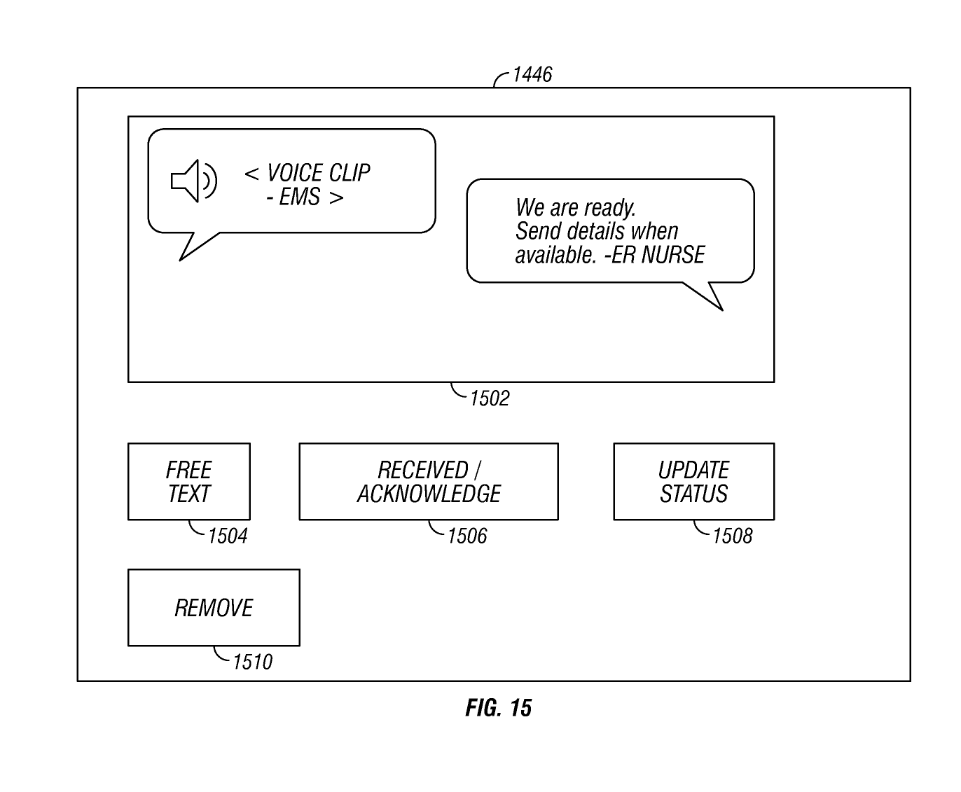

Communications module 1446 may be configured to facilitate communication between a user of EMS application 120 and another caregiver of system 100. Such communication may be initiated by selection of submit 1444. Communications module 1446 may be configured to send or receive messages from EMS application 120 as shown in FIG. 15.

FIG. 15 is an illustration of an example embodiment of communications module 1446. In addition to the components illustrated in FIG. 15, communications module 1446 may also include any of the options, modules, or input-output mechanisms described above, such as image attachment module 1408, injury map 1410, or voice recorder 1412. Communications module 1446 may include a conversation display 1502 configured to display the back-and-forth communications from a user of EMS application 120 and another caregiver. The display of communications may include, for example, text, an icon or pictogram of a voice clip, or an icon of a pending photograph. Furthermore, communication module 1446 may include a free text input, for which text may be freely entered by a user of EMS application 120. In addition, communication module 1446 may include an acknowledgment input 1506. Acknowledgment input 1506 may be configured to provide one-click or one-press acknowledgment communication to a sender of a message that the information has been received and acknowledged. Also, communications module 1446 may include an update status 1508 input. Update status 1508 input may be configured to resend information that was previously sent, such as that information presented in FIG. 14. Communications module 1446 may include a remove 1510 input, configured to remove communications or information that are pending a selection of, for example, update status 1508.

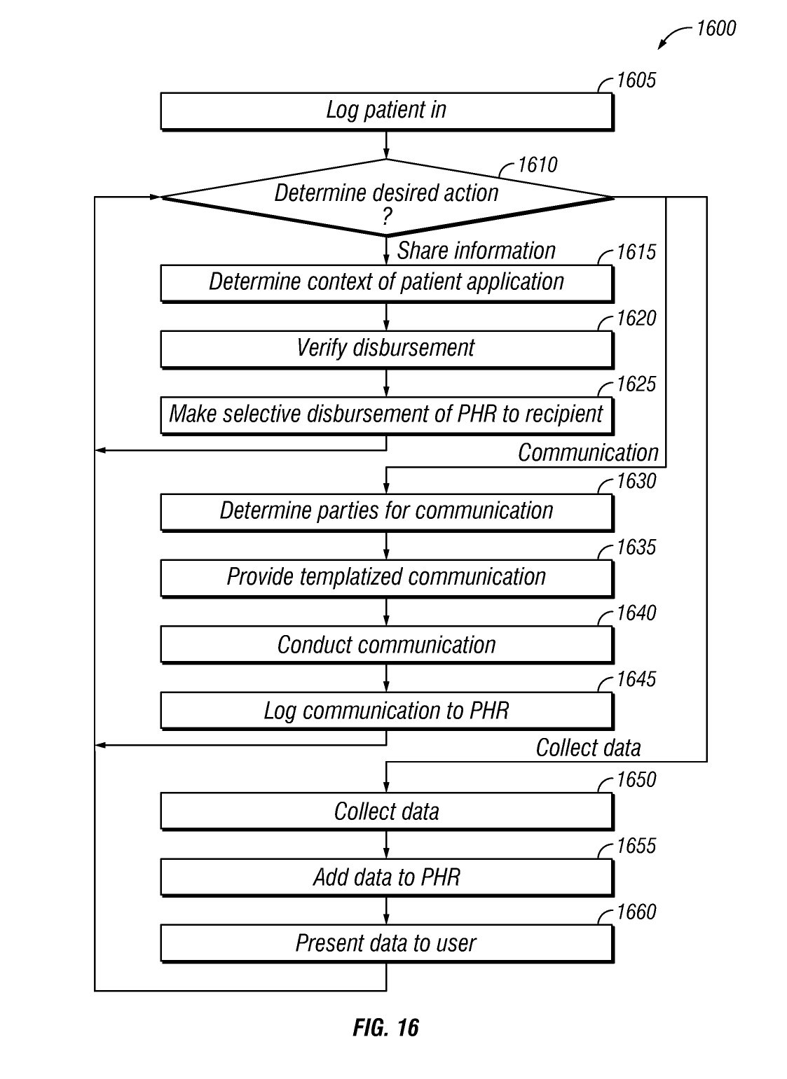

FIG. 16 illustrates an example embodiment of a method 1600 for medical information tracking. Method 1600 may perform any number or kind of steps in accordance with the configuration of system 100 as described above. For example, in 1605, a patient may be logged into a system for medical information tracking. Such a log-in may be performed by, for example, scanning a QR code provided by the patient, or by a username and password. The log-in of the patient may retrieve or otherwise make available a PHR associated with the patients.

In 1610, a desired action may be determined. Such a determination may be made on, for example, an application used by the patient in the system, or by an application used by another entity in the system. Depending upon the action determined, method 1600 may proceed to a suitable course of action.

If a share of information is determined to be desired, then in 1615 a context of the operation of patient application (or another application generating the share) may be determined. The context may be used to determine what portions of PHR are to be disbursed. The share may have been requested by, for example, a caregiver, or may have been initiated by the patient. The share may be handled by the system, such that requests and pushes of information may be centrally processed for authorization from the patient. Authorization for disbursement of the selected portions of the PHR may be verified in 1620. In 1625, the selective disbursement may be performed. Method 1600 may return to 1610.

If communication is determined to be desired, in 1630 the parties associated with the communication may be determined. In one embodiment, the communication may be made to an on-duty or on-call caregiver, or to a specified caregiver who is unavailable and thus has authorized on-duty or on-call caregivers to respond. An on-duty or on-call status may be preserved by the system such that at least one, or another minimum number, of a category of caregivers is available. In another embodiment, the communication may be made to a designated caregiver who is available. Communication transfer mediums and mechanisms may be secured. In 1635, templatized communication may be provided. Such templatized communication may present one or more predetermined forms for communicating medical information. In 1640, the communication may be conducted. In 1645, the communication may be logged. In one embodiment, such logging may be conducted to the PHR. Method 1600 may return to 1610.

If collecting medical data is desired, the in 1650 the data may be collected. The data may be input from a medical device, manually by a caregiver, or manually by a patient. The data may include any suitable medical data, such as a lab report, symptom details, or vital signs. In 1655, the data may be added to a PHR. In 1660, the data may be selectively presented to a user. Such selective presentation may include, for example, a delivery of only needed or relevant information for a given caregiver. Furthermore, such selective presentation may include a notification to a patient that a lab test is available, but given the sensitive contents or context of the lab test, the information will be available directly from a caregiver. Method 1600 may return to 1610.

Although FIG. 16 discloses a particular number of steps to be taken with respect to example method 1600, method 1600 may be executed with more or fewer steps than those depicted in FIG. 16. In addition, although FIG. 16 discloses a certain order of steps to be taken with respect to method 1600, the steps comprising this method may be completed in any suitable order. Method 1600 may be implemented using the systems, embodiments, and examples of FIGS. 1-15. In certain embodiments, method 1600 may be implemented partially or fully in software embodied in computer-readable storage media.

Although the present invention has been described with several embodiments, various changes and modifications may be suggested to one skilled in the art. It is intended that the present invention encompass such changes and modifications as fall within the scope of the appended claims.

What is claimed is:

1. A method for medical information communication, comprising:
verifying the identity of a patient;
determining a personal health record (PHR) controlled by the patient;
upon request of the patient, authorizing selective access to the PHR by an entity and selectively pushing information from the PHR to the entity;
performing a real-time medical information activity associated with the PHR and the entity; and
adding the activity to the PHR.

2. The method of claim 1, wherein authorizing selective access to the PHR includes determining an on-duty caregiver from a plurality of caregivers.

3. The method of claim 1, wherein the real-time medical information activity includes communication between the patient and a caregiver.

4. The method of claim 1, wherein the real-time medical information activity includes communication between the patient and a caregiver, the communication including selecting at least one template of medical information.

5. The method of claim 1, wherein the real-time medical information activity includes a notification that the patient is en-route to a medical facility.

6. The method of claim 1, wherein the PHR includes a plurality of electronic health records generated by a medical facility.

7. The method of claim 1, wherein the real-time medical information activity includes determining a wait period for a healthcare facility.

8. The method of claim 1, wherein the real-time medical information activity includes:
determining a geographical location of the patient; and
determining a prioritization of the patient based upon the determination of geographical location.

9. The method of claim 1, wherein the real-time medical information activity includes:
determining a medical-related form for the patient to sign;
prompting the patient to sign the form; and
corroborating the patient's identity.

10. An article of manufacture comprising:
a computer readable medium; and
computer-executable instructions carried on the computer readable medium, the instructions readable by a processor, the instructions, when read and executed, for causing the processor to:
verify the identity of a patient;
determine a personal health record (PHR) controlled by the patient;
upon request of the patient, authorize selective access to the PHR by an entity and selectively pushing information from the PHR to the entity;
perform a real-time medical information activity associated with the PHR and the entity; and
add the activity to the PHR.

11. The article of claim 10, wherein authorizing selective access to the PHR includes determining an on-duty caregiver from a plurality of caregivers.

12. The article of claim 10, wherein the real-time medical information activity includes communication between the patient and a caregiver.

13. The article of claim 10, wherein the real-time medical information activity includes communication between the patient and a caregiver, the communication including selecting at least one template of medical information.

14. The article of claim 10, wherein the real-time medical information activity includes a notification that the patient is en-route to a medical facility.

15. The article of claim 10, wherein the PHR includes a plurality of electronic health records generated by a medical facility.

16. The article of claim 10, wherein the real-time medical information activity includes determining a wait period for a healthcare facility.

17. The article of claim 10, wherein the real-time medical information activity includes:
determining a geographical location of the patient; and
determining a prioritization of the patient based upon the determination of geographical location.

18. The article of claim 10, wherein the real-time medical information activity includes:
determining a medical-related form for the patient to sign;
prompting the patient to sign the form; and
corroborating the patient's identity.

19. A system for medical information communication, comprising:
a processor;
a computer readable medium communicatively coupled to the processor; and
computer-executable instructions carried on the computer readable medium, the instructions readable by the processor, the instructions, when read and executed, for causing the processor to:
verify the identity of a patient;
determine a personal health record (PHR) controlled by the patient;
upon request of the patient, authorize selective access to the PHR by an entity and selectively pushing information from the PHR to the entity;
perform a real-time medical information activity associated with the PHR and the entity; and
add the activity to the PHR.

20. The system of claim 19, wherein authorizing selective access to the PHR includes determining an on-duty caregiver from a plurality of caregivers.

21. The system of claim 19, wherein the real-time medical information activity includes communication between the patient and a caregiver.

22. The system of claim 19, wherein the real-time medical information activity includes communication between the patient and a caregiver, the communication including selecting at least one template of medical information.

23. The system of claim 19, wherein the real-time medical information activity includes a notification that the patient is en-route to a medical facility.

24. The system of claim 19, wherein the PHR includes a plurality of electronic health records generated by a medical facility.

25. The system of claim 19, wherein the real-time medical information activity includes determining a wait period for a healthcare facility.

26. The system of claim 19, wherein the real-time medical information activity includes:
determining a geographical location of the patient; and
determining a prioritization of the patient based upon the determination of geographical location.

27. The system of claim 19, wherein the real-time medical information activity includes:
determining a medical-related form for the patient to sign;
prompting the patient to sign the form; and
corroborating the patient's identity.
